(19) United States
(12) Patent Application Publication
(10) Pub. No.: US 2014/0337186 A1
(43) Pub. Date: Nov. 13, 2014

(54) METHOD AND SYSTEM FOR ASSOCIATING CONTAINER LABELS WITH PRODUCT UNITS

(71) Applicants: ANTONIO SABAREZ, II, MONTEREY, CA (US); ABEL GONZALEZ, SALINAS, CA (US); ALVARO GONZALEZ, SALINAS, CA (US)

(72) Inventors: ANTONIO SABAREZ, II, MONTEREY, CA (US); ABEL GONZALEZ, SALINAS, CA (US); ALVARO GONZALEZ, SALINAS, CA (US)

(21) Appl. No.: 14/338,310

(22) Filed: Jul. 22, 2014

Related U.S. Application Data
(63) Continuation-in-part of application No. 13/347,702, filed on Jan. 11, 2012.

(51) Int. Cl. G06Q 10/08; G06Q 30/00

(52) U.S. Cl. CPC G06Q 10/087; G06Q 30/018; G06Q 10/0832
USPC 705/28

(57) ABSTRACT

Methods, systems and devices for enabling the geolocational monitoring, tracking and management of an agricultural workflow are provided. A first version of the method includes establishing a serial number for shipping containers which corresponds to a software database record that is readily editable. The invented method avoids the need for correcting errors on detailed physical labels placed on produce shipping containers, thereby increasing overall efficiency of sending fresh produce to the stream of commerce. Increasing the speed at which said produce enters the marketplace allows growers to realize more of the value of each crop.

### CLAIM FOR PRIORITY

The present application is a continuation-in-part of currently pending U.S. patent application Ser. No. 13/347,702 titled “METHOD, SYSTEM AND DEVICE FOR A GEOLOCATIONAL TRACKING AND MANAGEMENT OF AGRICULTURAL WORKFLOW” filed on Jan. 11, 2012. The present application claims the priority date of filing for this U.S. patent application Ser. No. 13/347,702. Furthermore, U.S. patent application Ser. No. 13/347,702 is incorporated into the present disclosure in its entirety and for all purposes.

### FIELD OF THE INVENTION

The present invention relates generally to methods and systems of agricultural process monitoring and management, and more particularly to associating aspects and elements of agricultural production, processing and delivery with distinguishable persons, goods and locales.

### BACKGROUND OF THE INVENTION

Many environments within the agricultural sector have proven to be resistant to harvesting the benefits of information technology than most industrial and manufacturing operations. In many aspects of prior art agricultural production and foodstuff management, the logging and association of agricultural inputs and relevant production factors, e.g., seed, fertilizer, pesticides, plant nutrients, and labor, with specific food items, locations and fields of plant growth, individual farm workers, shipping and processing agents, and the stream of agricultural commerce have not been optimally addressed or enabled by the prior art.

Escalating concerns over food safety and immigrant worker tracking in the first decade of this century have significantly increased in importance in the consciousness of the public and numerous United States government agencies and officials. In particular, the importance of control, tracking and documenting of the persons and phases through which an individual foodstuff has contact, or may be affected by, has increased in public and governmental priority in the last ten years. As a consequence of these concerns, many government agencies are expanding their vigilance over, and legally enforceable duties of, vendors and firms in the food industry.

Agricultural producers are required by law to have certain labeling information on containers of produce shipped. This is largely for health and safety concerns. The prior art addresses container labeling requirements by pre-labeling containers and storing them in a warehouse until needed. Once needed the containers are sent to a work site where they are filled. This process is not immune to error. Often, a container with an incorrect label is sent to a work site. For example, a container labeled to ship strawberries is sent to a work site where growers are cultivating lettuce. Since the container may not legally be shipped while incorrectly labeled, the labeling has to be corrected at the work site. This is a wholly inefficient process.

There is therefore a long felt need to provide systems and methods that improve the application of information technology to provide a more efficient means for tracking and monitoring agricultural and food shipments.

### OBJECTS OF THE INVENTION

It is an object of the method of the present invention to enhance food safety.

It is another object of the method of the present invention to provide improved devices, systems and methods that enable the monitoring and analysis of aspects, conditions and outcomes of an agricultural production process.

It is another object of the method of the present invention to increase accountability of agricultural workers by enabling the tracking of individual workers with reference identifiers that are recorded in association with time, date and location information.

It is another object of the method of the present invention to prepare shipping containers for produce such that the labeling is readily changeable through use of a software database.

### SUMMARY OF THE INVENTION

These and other objects of the present invention are made obvious in light of this disclosure, wherein methods, systems and computer-readable media for monitoring and managing agricultural production process. According to a first aspect of the method of the present invention, a method is provided that applies labeling to shipping containers for goods and produce with electronic labeling. This method proceeds by identifying a product unit, the method comprising: generating a plurality of unit identifiers, each unit identifier including a source entity identifier and a unique unit serial number; converting the plurality of unit identifiers into a machine-readable format; printing a unique image of each of the plurality of unit identifiers in the machine-readable format onto a separable adhesive label and/or alternatively or additionally applying ink to one or more containers to imprint one or more unit identifiers onto one or more containers; affixing each adhesive label onto a separate unit container of a plurality of unit containers; distributing at least one unit container to a product source location; associating the label of the at least one unit container with a unit of goods at the product source location; associating unit identifier of the label of the at least one unit container with software record; and populating the software record with a goods identifier, the goods identifier indicating the identity of the unit of goods.

This method allows a particular shipping container to be physically labeled simply by a number and a work site location. The number corresponds to an entry in a software database, the database containing additional information about the container and is readily editable.

According another optional aspect of the invention, an element of crop cultivation is instantiated at or proximate to an identified area of plant cultivation, assigned an element identifier, or “marker”, and then tracked by referenced to the element marker as the element passes along the stream of commerce from the area of plant cultivation and to the consumer or end user. The database records are then automatically populated through use of these “markers” when selected container.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

U.S. Pat. No. 8,037,846 (inventor: Pratt and issued on Oct. 18, 2011) titled “Method and system for tracking and managing animals and/or food products”; U.S. Pat. No. 7,904,373 (inventors: Kimle, et al. and issued on Mar. 8, 2011) titled “Method for electronically initiating and managing agricultural production contracts”; U.S. Pat. No. 7,772,983 (inventors: Grose, et al. and issued on Aug. 10, 2010) titled “Apparatus for tracking carcass”; U.S. Pat. No. 7,702,462 (inventors: Fuessley, et al. and issued on Apr. 20, 2010) titled “Method and apparatus for tracking individual plants while growing and/or after harvest”; U.S. Pat. No. 6,745,127 (inventor: Crosby and issued on Jun. 1, 2004) titled “System and method for tracking and reporting pesticide and fertilizer use on agricultural products”; U.S. Pat. No. 6,554,188 (inventors: Johnson, et al. and issued on Apr. 29, 2003) titled “Terminal for an active labeling system”; and U.S. Pat. No. 8,152,063 (inventors: Grant, et al. and issues on Apr. 10, 2012) entitled, “Case Labeling for Field-Packed Produce.”

The publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE FIGURES

These, and further features of various aspects of the present invention, may be better understood with reference to the accompanying specification, wherein:

FIG. 1 is an illustration of a crop cultivation area A located within a larger geographic area;

FIG. 2 is a schematic of the GPS device of FIG. 1;

FIG. 3 is a block diagram of an electronics communications network comprising the Internet, the GPS device of FIGS. 1 and 2, a GIS, and a database server;

FIG. 4 is an illustration of a first area data set record that may be stored in the GPS device of FIGS. 1, 2 and 3, the GIS and the database server of FIG. 3, includes data relating the area of FIG. 1 to a crop area, a GPS location, a worker identifier, a plurality of area inputs to the area A, and/or historical data;

FIG. 5 is process diagram of certain aspects of the method of the present invention as enabled by the GPS device of FIGS. 1, 2 and 3 and the electronics communications network of FIG. 2;

FIG. 6 is a flowchart of certain other aspects of the method of the present invention related to monitoring a distinguishable crop growing area that may be implemented by the GPS device of FIGS. 1, 2 and 3 and the electronics communications network of FIG. 3;

FIG. 7 is an illustration of an exemplary first crop element record that includes a crop area identifier rand information related to the crop area and crop element of FIG. 1;

FIG. 8 is a schematic of an RFID device containing a crop element record of FIG. 7, a worker record and/or a crop area record;

FIG. 9 is an illustration of an exemplary first worker record that includes a worker identifier and information related to the worker and crop area(s) and crop element(s) of FIGS. 1, 4 and 7;

FIG. 10 is an illustration of a database of FIG. 2 that may be stored in a device, computer or server of FIG. 1, 2, or 3 and comprising information partially or entirely of FIGS. 2, 4 and 7;

FIG. 11 is a flow chart of a prior art method of associating a product unit with a shipping container;

FIG. 12 is a flow chart depicting a first aspect of the invented method for associating a product unit with an invented label and a shipping container;

FIG. 13A is an illustration of an exemplary invented label;

FIG. 13B is a block diagram of an exemplary software label record that is associated with the exemplary label of FIG. 13A;

FIG. 14A is a perspective view of a first stamp that may be used to mark the invented label of FIG. 13A with a country of origin indication;

FIG. 14B is a perspective view of a second stamp that may be used to mark the invented label of FIG. 13A with a particular date;

FIG. 14C is a perspective view of a third stamp that may be used to mark the invented label of FIG. 13A with a selectable date;

FIG. 14D is a perspective view of a marker that may be used to manually mark the invented label of FIG. 13A;

FIG. 15 is a software flowchart of aspects of the invented method that may be implemented by one or more systems or devices the communications network of FIG. 3, wherein a particular product unit is associated with a software record, and information from the software record is associated with a label attached to or coupled with a product unit;

FIG. 16 is a software flowchart that may be implemented within the communications network of FIG. 3, wherein a software record is updated;

FIG. 17 is a software flowchart of additional aspects of the invented method that may be implemented by one or more systems or devices the communications network of FIG. 3, wherein a particular product unit is associated with a software record, and information from the software record is associated with a label attached to or coupled with a product unit;

FIG. 18 is a software flowchart of additional aspects of the invented method that may be implemented by one or more systems or devices the communications network of FIG. 3, wherein information of a software label record is requested;

FIG. 19 is a software flowchart of printer operations in the printing of an invented label;

FIG. 20A is a block diagram of a message containing label record update information;

FIG. 20B is a block diagram of a query message containing information from a labeled software record;

FIG. 20C is a block diagram of a printer message that directs a printer to print an invented label;

FIG. 20D is a block diagram of a label record message containing label record information;

FIG. 20E is a block diagram of a palette message that associates a pallet label record with a plurality of additional label records; and

FIG. 21 is a front view of a pallet containing a plurality of containers wherein the pallet and each container is marked with a unique invented label.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

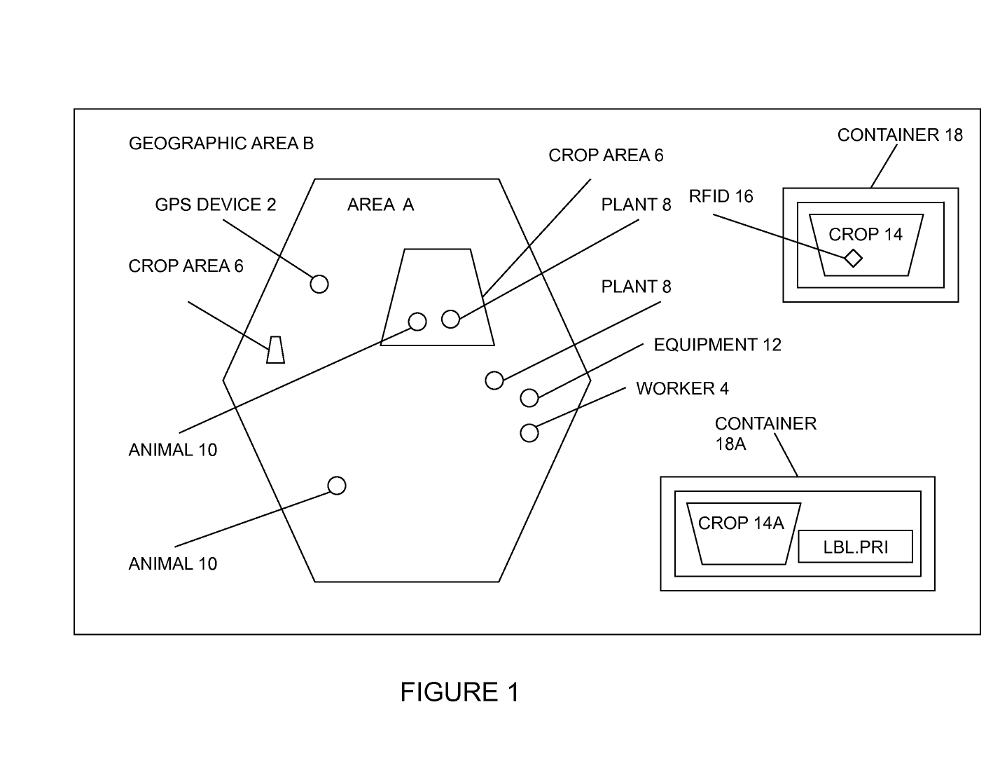

Referring now generally to the Figures and particularly to FIG. 1, FIG. 1 is an illustration of a crop cultivation area A located within a larger geographic area B. A GPS device 2 is placed within an area A wherein a human worker 4, a defined crop growth area 6 (hereinafter, “crop area” 6), a plurality of plants 8, a plurality of animals 10, and a mobile farm equipment 12, such as a tractor or a plant bagger, are located. The GPS device 2 accepts and records information, including but not limited to information identifying or describing a quality, aspect or element related or provided regarding the area A, one or more crop areas 6, equipment 12, and life forms 4, 8 & 10 located within the area A. The recorded information is associated with a GPS signal received by the GPS device 2 and optionally (a.) a crop area identifier CE.ID; (b.) information related to or identifying a crop area 6, the Area A, a worker 4, an equipment 12, and/or a plant 8, and/or (c.) a time date stamp 14B.

An exemplary crop 14 comprises an agricultural output, e.g., plants, fruits, vegetables, meat sections, livestock, and/or other suitable agricultural process outputs known in the art, that has been harvested from, collected at, or removed from a distinguishable and identified crop area 6. An RFID marker device 16 travels with the crop element 14 (or “crop 14”) in the stream of commerce optionally with or within a crop container 18. The crop 14 may be or comprise, for example but not limited to, an individual animal, tree or plant, or a plurality, bushel, or container load of fruit, vegetables, livestock or other suitable agricultural process output known in the art. An exemplary first crop container 18A segregates and holds an exemplary first product unit 14A selected from the crop 14 and supports tracking of the first product unit 14A as the first container 18A is transported and processed through the stream of commerce extending from the originating and identified crop area 6 and to the consumer, and optionally beyond delivery to the consumer and in one or more stages of recycling, composting, and/or waste management. A prior art label LBL.PRI is optionally affixed to the first container 18A.

The RFID marker 16 may send and receive information to and from a communications network 20, the Internet 22, a telephony network 30, one or more GPS devices 2, GIS servers 24, database servers 26, network computers 28, and RFID writers/readers 32 to generate and store information related to the instant crop 14 as the crop 14 is moved through the stream of commerce.

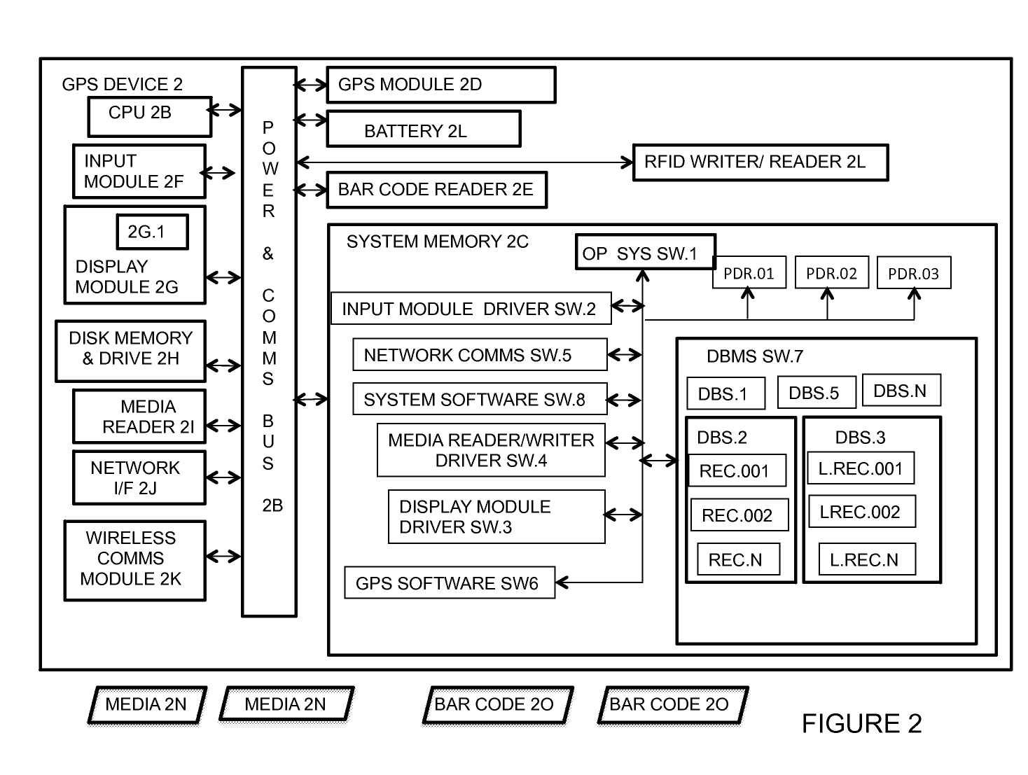

Referring now generally to the Figures and particularly to FIG. 2, FIG. 2 is a schematic of the GPS device 2 of FIG. 1. It is understood that one, more than one, or all of the elements and aspects of the GPS device 2 may also be present in one or more GIS servers 24, database servers 26, and/or network computers 28.

An internal power and communications bus 2A bi-directionally communicatively couples a central processing unit 2B (“CPU” 2B), a system memory 2C, a GPS module 2D, a visual pattern bar code reader 2E, a data input module 2F, a display module 2G having a display screen 2G1, a disk memory, controller and disk memory module 2H, an electronic media reader 21, a network interface module 2J, a wireless communications module 2K, and an RFID writer/reader. A battery 2M is further coupled with the GPS device 2 elements 2A-2K by means of the power and communications bus 2A and provides electrical power to the elements 2A-2K of the GPS device 2. The electronic media reader 21 and each of a plurality of electronic media 2N are selected are configured to enable the transfer of software encoded data and instructions between the GPS device 2 and the electronic media 2N.

The bar code reader 2E and each of a plurality of bar code patterns 20 are selected and configured to enable the transfer of encoded identifiers, data and instructions as encoded in the bar code pattern and the electronic media 2N. One or more identifiers, data and instructions of one or more of the bar code patterns may identify and/or relate to one or more human workers 4, crop areas 6, plants 8, animals 10, equipment 12, and/or crops 14. Alternatively or additionally, one or more identifiers, data and instructions of one or more of the bar code patterns 20 may identify and/or relate to an identification of a plant seed, an identification of a plant fertilizing agent, an identification of a plant nutritional agent, an identification of a volume of water, an identification of a pest reduction agent, an identification of a plant disease, and/or other data related to, describing or identifying an agricultural process input. Still alternatively or additionally, one or more identifiers, data and instructions of one or more of the bar code patterns 20 may identify and/or relate to an agricultural process output, such as a fruit or vegetable, a measure of a harvested plant element, an animal or animal product, and/or other agricultural process output known in the art.

The RFID reader/writer 2L and the RFID marker 16 are selected and configured to communicate, store and/or exchange information relating to the Area A, the associated crop 14, the instant crop area 6, an identification of a plant seed, an identification of a plant fertilizing agent, an identification of a plant nutritional agent, an identification of a volume of water, an identification of a pest reduction agent, an identification of a plant disease, and/or other data related to, describing or identifying an agricultural process input. Still alternatively or additionally, information communicated between the RFID marker 16 and the RFID reader/writer 2L may identify and/or relate to an agricultural process output comprised within the crop 14 associated with the RFID marker 16, such as a fruit or vegetable, a measure of a harvested plant element, an animal or animal product, and/or other agricultural process output known in the art.

The GPS device 2 system memory 2C has various software programs and utilities stored therein, to include, but not limited to, an operating system SW.1, an input module driver software SW.2, a display module driver software SW.3, a media reader module driver software SW.4, a network communications software SW.5, a GPS software SW.6, a database management software SW.7 (hereinafter “DBMS” SW.7) and a system software SW.8. The DBMS SW.7 includes a plurality of software databases DBS.1, DBS.2, DBS.3 & DBS.N. The system software SW.8 enables and directs the GPS device 2 in the performance of the steps and aspects of the invention as presented in the Figures and disclosed in accompanying text. The operating system software SW.1 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, VISTA™ or WINDOWS 7™ operating system as marketed by Microsoft Corporation of Redmond, Wash.; or the MAC OS X operating system or iPhone G4 OS™ as marketed by Apple, Inc. of Cupertino, Calif.

The database management system DBMS SW.7 may be or comprise an object oriented database management system (“OODBMS”) and/or a relational database management system (“RDBMS”), and one or more databases DBS.1-DBS.N may be or comprise an object oriented database and/or a relational database. The DBMS SW.7 may be selected from prior art database management systems including, but not limited to, Objectivity/DB 10™ marketed by Objectivity, Inc. of Mountain View, Calif.; a Database 2™, also known as DB2™, relational database management system as marketed by IBM Corporation of Armonk, N.Y.; and the Advantage Database Server™ relational database management system.

The GPS device 2 may be or comprise (a.) an IPHONE G4™ internet enabled cellular telephone marketed by Apple, Inc., of Cupertino, Calif.; (b.) an IPAD™ tablet computer marketed by Apple, Inc., of Cupertino, Calif.; (c.) or other suitable or handheld portable computational communications device known in the art.

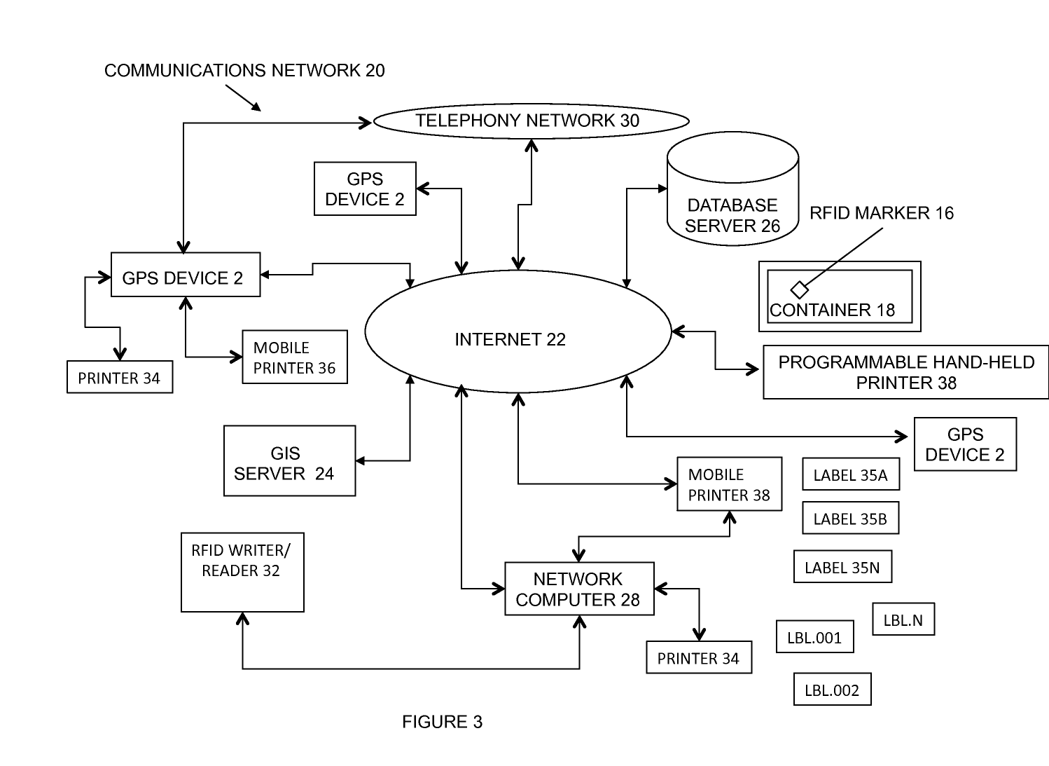

The system software SW.8 directs the GPS device 2 and the elements 20 through to execute, instantiate and/or comply with the software-enabled aspects of the method of the present invention. The input module driver software SW.2 directs and enables the CPU 2B and the input module 2F in receiving and recording in the system memory data and commands received from the input module 2F, wherein the input module may be a computer keyboard and/or a point and click selection device, or other suitable user input device known in the art. The display module software module SW.3 directs and enables the CPU 2B and the video display module 2G in rendering commands, messages, data and graphics via the video display module 2G. The media reader/writer driver software SW.4 directs and enables the CPU 2B and the media reader/writer in sending and receiving information to and from the media 2N. The network communications software SW.2 directs and enables the CPU 2B and the GPS device 2 in general to bi-directionally communicate with the communications network 20 of FIG. 3.

A printer driver software PDR.01 enables the GPS device or the network computer 28 to provide data and instructions to a printer 34 of FIG. 3 to print images on conventional label stock to generate labels 35A-35N and invented labels LBL.001-LBL.N. A mobile printer driver software PDR.01 enables the GPS device or the network computer 28 to provide data and instructions to a wireless-communications enabled portable printer 36 of FIG. 3 to print images on conventional label stock to generate labels 35A-35N and invented labels LBL.001-LBL.N. A programmable handheld printer driver software PDR.03 enables the GPS device or the network computer 28 to provide data and instructions to a programmable handheld printer 38 of FIG. 3 to form pattern images on external surfaces of containers 18.

The printer 34 and/or the mobile printer 36 may be an HP 6700™ ink jet printer marketed by Hewlett Packard, Inc. of Palo Alto, Calif., a Brother MW-260™ hand held thermal printer marketed by Brother International of Bridgewater, N.J., an HP Officejet 100™ mobile printer marketed by Hewlett Packard, Inc. of Palo Alto, Calif., a Brother PocketJet 6 Plus PJ663-K™ mobile printer marketed by Brother International of Bridgewater, N.J., or other suitable ink, laser, inkjet or thermal printer known in the art.

Referring now generally to the Figures and particularly to FIG. 3, FIG. 3 is a schematic of an electronics communications network 20 comprising the Internet 22, the GPS device 2 of FIGS. 1 and 2, a GIS server 24, a database server 26, a network computer 28, a telephony network 30, an RFID writer/reader 32, a printer 34, a wireless-communications enabled portable printer 36 (hereinafter, “mobile printer” 36), and a programmable handheld printer 38.

The programmable handheld printer 38 may be a HANDJET MODEL 250 or a HANDJET MODEL 260 as marketed by EBS Ink-Jet Systeme GmbH of Nümbrecht-Elsenroth, Germany; or a SPEED-I-JET as marketed by Ernst Reiner GmbH & Co.KG of Furtwangen Germany; or other suitable programmable handheld printer known in the art.

It is understood that the network 20 preferably includes a plurality of GPS devices 2, GIS servers 24, database servers 26, network computers 28 and printers 34-38.

The GPS device 2 is communicatively coupled to the Internet 22 and one or more GIS servers 24, database servers 26, and network computers 28 the by means of the network interface module 2J and/or the wireless communications module 2K. An optional intervening telephony network 30 provides an alternate or additional bi-directional communications pathway between one or more GPS devices 2, GIS servers 24, database servers 26, and network computers 28. Information transmitted from the GPS device 2 may be stored at and accessed from the GIS server 24, the database server 26, and/or the network computer 28, whereby a human analyst may examine the information in association with (a.) an identifier of a specific crop cultivation area, e.g., area A, (b.) an identifier of an individual worker 4; (c.) an identifier of a crop area 6; (d.) an identifier of an equipment 12; and/or (e.) an identifier of a crop element harvested from a plant 8.

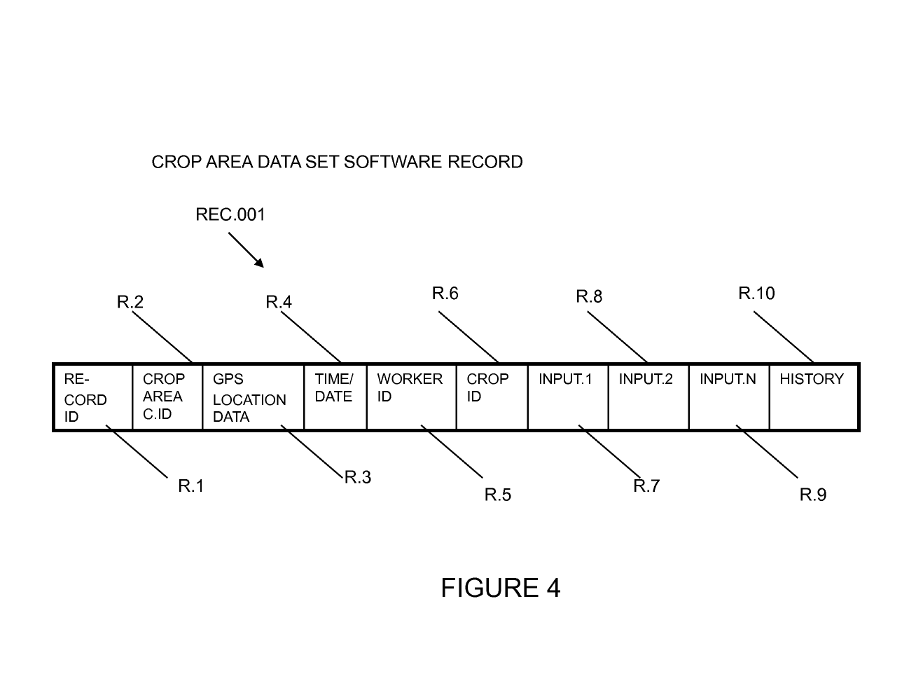

Referring now generally to the Figures and particularly to FIG. 4, FIG. 4 is an illustration of an exemplary crop area data set record REC.001 contained within a database DBS.1-DBS.N. The data set record REC.001 may include a unique record identifier data R.1 relating a crop area identifier A.ID R.2 that identifies s specific crop area 6 (hereinafter “instant crop area” 6″) and associates with Area A, a GPS location data R.3 of one or more associated crop areas 6, one or more time and data stamps R.4 that relate to aspects or information related to the Area A, the instant crop area 6, and/or one or more associated crops 14, one or more worker identifiers R.5, a plurality of data inputs R.7-R.9, that relate to Area A, the instant crop area 14 and/or a specified crop area 6 of Area, and/or historical data R.10 that relate to aspects or information related to one or more associated crops 14, and/or one or more workers 4 identified by a worker identifier R.5. The worker identifier R.5 may be communicated to the GPS device 2 and entered into the first area data set record REC.001 as read by the GPS device 2 via (a.) the GPS device 2 data input device, (b.) radio transmission, (c.) radio signal from a radio frequency identification device 16, and/or (d.) a bar code detection by the bar code reader 2E. The area input entries input.1-input.N R.7-R.9 include data describing the type, time, date, and condition of individual area inputs and other information related to individual and distinguishable area data inputs. The information R.1-R.10 contained within the data set record REC.001 may be received into the GPS device 2 by means of bar code patterns 20, operator manipulation of the input module 2F, reading from one or more media 2N, and/or from the communications network 20.

One or more data input entries R.7-R.9 my comprise or include a measure of labor hours, an identification of a plant seed, an identification of a plant fertilizing agent, an identification of a plant nutritional agent, an identification of a volume of water, an identification of a pest reduction agent, an identification of a plant disease, and/or other data related to, describing or identifying an agricultural process input. Alternatively or additionally, one or more data input entries R.7-R.9 my comprise or include information that identifies and/or relates to an agricultural process output, such as a fruit or vegetable, a measure of a harvested plant element, an animal or animal product, and/or other agricultural process output known in the art.

Further alternatively or additionally, or more data input entries R.7-R.9 may comprise or include information that identifies and/or relates to a marker of a distinguishable element of crop output and/or an association of the marker of the element of crop output in tracking the movement in time and space of the element of crop output.

The information each of the crop area record data fields R.1-R.10 of the each crop area records.REC.001-REC.N may be entered into the comprising crop area record REC.001-REC.N by means of manual input into the GPS device 2, the GIS server 24, the database server 26, the network computer 28, or the RFID reader/writer 32 in combination or in singularity.

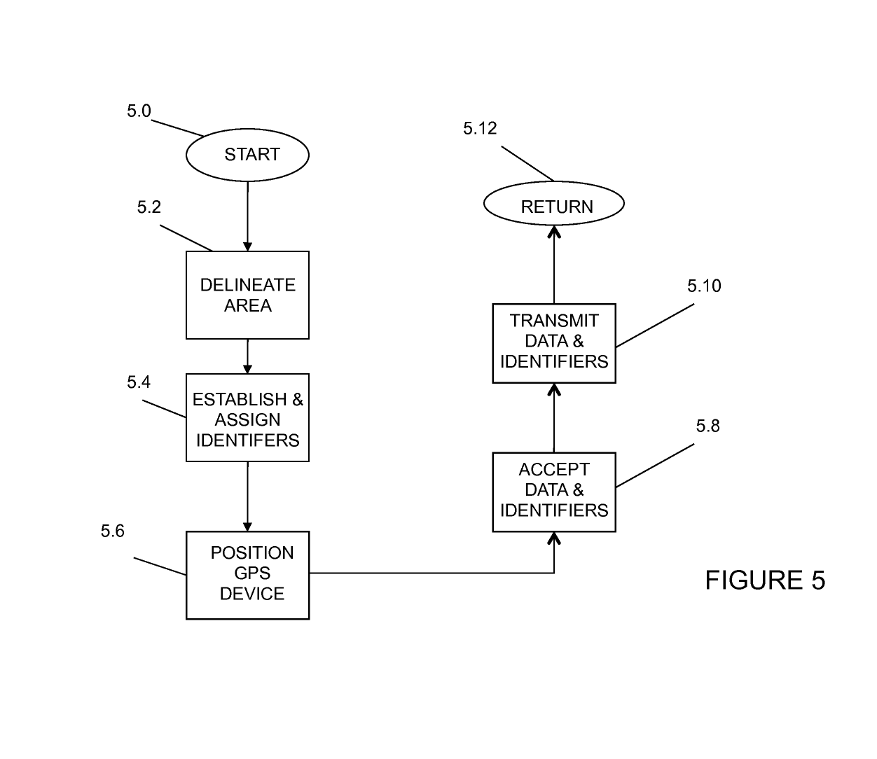

Referring now generally to the Figures and particularly to FIG. 5, FIG. 5 is process diagram of certain aspects of the method of the present invention. In step 5.2 a crop cultivation Area A, the instant crop area 6, and other crop areas 6 are delineated and assigned identifiers. In step 5.4 identifiers are assigned to one or more crop areas 6, area data inputs R.7-R.9, workers 4, equipment 12, plants 8 and/or animals 10, wherein the instant crop area 6 is identified by a crop area identifier R.2. The GPS device 2 of FIGS. 1, 2 and 3 is positioned in step 5.6 within or proximate to the Area A delineated in step 5.2, and in step 5.8 data and identifiers related to activity in the instant crop area 6 is recorded in the GPS device 2 and optionally formatted in crop area data set software records REC.001-REC.N. The data, identifiers and optionally area data set software records REC.001-REC.N are transmitted from the GPS device 2 via the Internet 22 and/or the telephony network 30 to the GIS server 24 and/or the database server 20.

The GPS device 2, the database server 20, the GIS server 24, and/or the network computer 28 may be a (a.) a network-communications enabled SUN SPARCSERVER™ computer workstation marketed by Sun Microsystems of Santa Clara, Calif. running LINUX™ or UNIX™ operating system; (b.) a network-communications enabled personal computer configured for running WINDOWS XP™, VISTA™ or WINDOWS 7™ operating system marketed by Microsoft Corporation of Redmond, Wash.; (c.) a VAIO FS8900™ notebook computer marketed by Sony Corporation of America, of New York City, N.Y.; (d.) a PowerBook G4™ personal computer as marketed by Apple, Inc. of Cupertino, Calif.; or an IPAD™ tablet computer as marketed by Apple, Inc. of Cupertino, Calif.

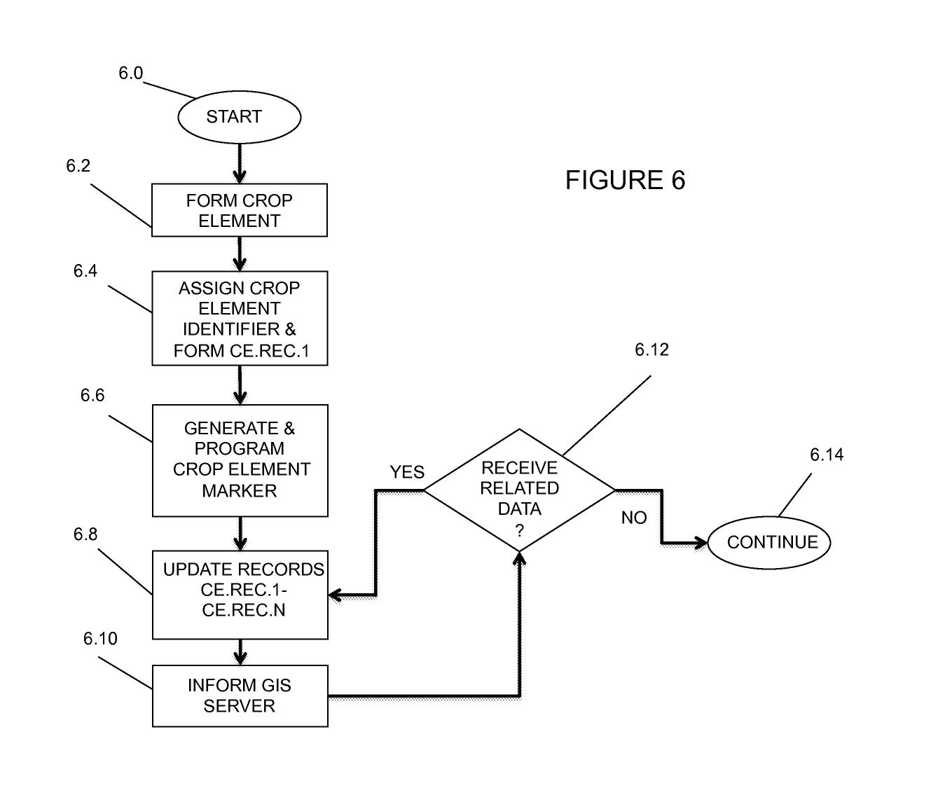

Referring now generally to the Figures and particularly to FIG. 6, FIG. 6 is a flowchart of certain other aspects of the method of the present invention related to monitoring a crop element 14 that may be implemented by the GPS device 2 and the electronics communications network. In step 6.2 a crop element 14 is formed and a crop identifier CE.ID is assigned to the crop element 14 and an exemplary crop element record C.REC. 1 is initiated in step 6.4 and a unique crop element record identifier CE.1 is assigned to the instant exemplary crop element record C.REC.001. A crop element marker, such as an RFID or a bar code pattern 20 is generated and/or marked by printing or programmed in step 6.6 with a crop element identifier CE.ID, and in step 6.8 the crop element record C.REC.001 is updated with identification information CE.ID in the second crop element data field CE.2 of the crop element identifier CE.ID. The GPS device 2 updates the GIS server 24 and/or the database server 26 via the electronics communications network 20 with the information DATA.1-DATA.N received in step 6.8. When the electronics communications network 20 receives in step 6.12 additional information related to the crop element identifier CE.ID or the instant crop area 6, and cycles through step 6.8 and step 6.10 to again update the exemplary crop element record C.REC.001 and/or the GIS device 2 with the information DATA.1-DATA.N received or detected in step 6.12.

One or more crop records CE.REC.001-CE.REC.N may then be stored and updated with information of crop element record data fields CE.1-CE.10, wherein the stored information may be generated by and/or received by and/or stored in whole or in part in information technology systems communicatively coupled with the Internet 22 and/or or one or more GPS devices 2, communications networks 20, telephony networks 30, one or more GPS devices 2, GIS servers 24, database servers 26, network computers 28, and RFID writers/readers 32 in combination or in singular.

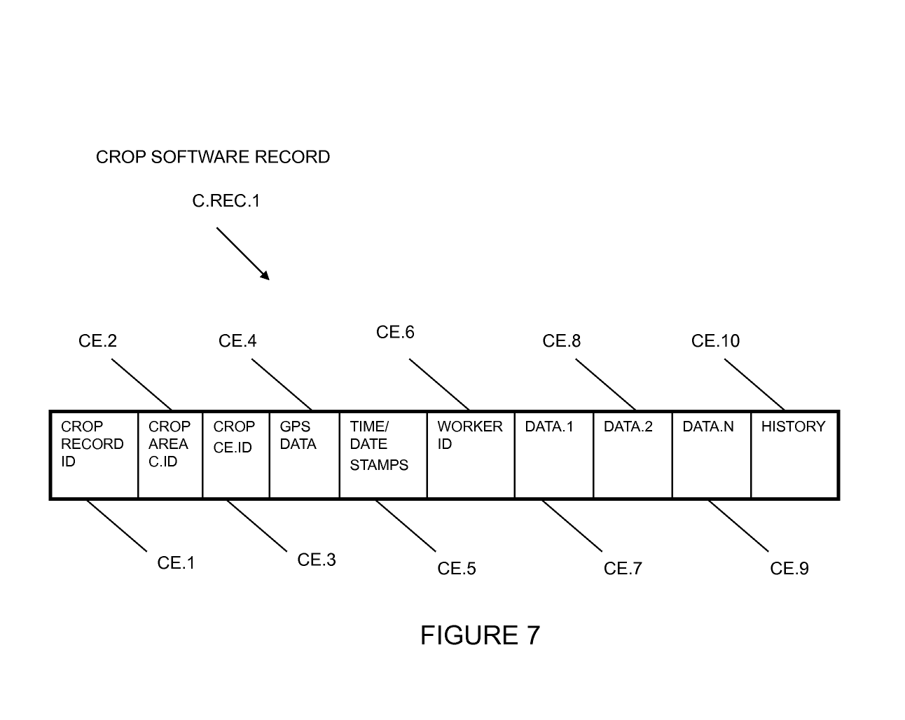

Referring now generally to the Figures and particularly to FIG. 7, FIG. 7 is an illustration of a first crop element record C.REC.001 that includes data relating a first crop element 14 with a originating crop area identifiers CE.ID, the identified crop area 14 being the location from which the crop element 14 was grown, harvested and/or collected and formed. The first crop element record C.REC.001 further comprises a crop element record identifier CE.1, the crop element identifier CE.ID, GPS location data CE.4 optionally related to at least one data DATA.1-DATA.N, time date/stamps CE.5 optionally related to at least one data DATA.1-DATA.N, one or more worker identifiers CE.8 associated with individual workers 4, a plurality of crop data entries DATA.1-DATA.N CE.7-CE.9 related to the first crop element 14 and/or the originating instant crop area 16, and historical data CE.10.

One or more crop data entries DATA.1-DATA.N CE.7-CE.9 and/or the historical data may comprise information relating to the Area A, the associated crop 14, the instant crop area 6, an identification of a plant seed, an identification of a plant fertilizing agent, an identification of a plant nutritional agent, an identification of a volume of water, an identification of a pest reduction agent, an identification of a plant disease, and/or other data related to, describing or identifying an agricultural process input, an agricultural process output comprised within the crop 14 associated with the RFID marker 16, such as a fruit or vegetable, a measure of a harvested plant element, an animal or animal product, and/or other agricultural process output known in the art.

One or more of the plurality of data entries DATA.1-DATA.N may describe the change of condition and/or location of the first crop element 14 as the first crop element 14 is grown or transported from the first area A or exemplary instant crop area 6 and passes through the stream of commerce. The responsibility for the travel time, travel delays and decline in condition of the first crop element 14 may thus be assigned with greater confidence and integrity by reference to the information contained within the first crop element record C.REC.001 or elsewhere in a database DBS.1-DBS.N of the GPS device 2, and one or more GIS servers 24, database servers 26, and/or network computers 28.

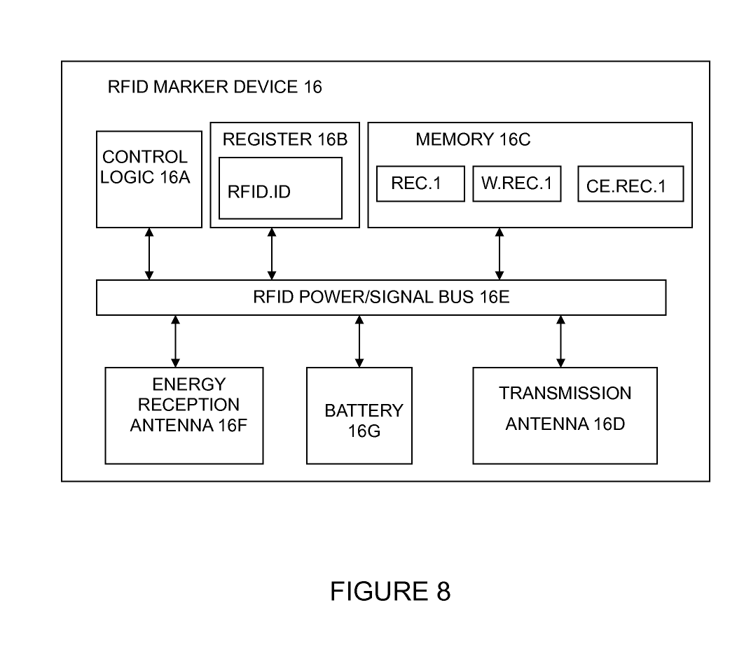

FIG. 8 is a schematic of the RFID device 16 containing a crop element identifier CE.ID of FIG. 7. A control logic 16A, a register 16B, optional memory 16C, and transmission antenna 16D are communicatively coupled with an RFID power and signal bus 16E. Electrical energy received by an energy reception antenna 16F is transferred to a battery 16D via the RFID power and signal bus 16E. Electrical power is additionally provided via the RFID power and signal bus from the battery 16G to the control logic 16A, register 16B and memory 16C. The register 16B stores the crop element identifier CE.ID and optionally the memory stores one or more crop area records C.REC.001-C.REC.N.

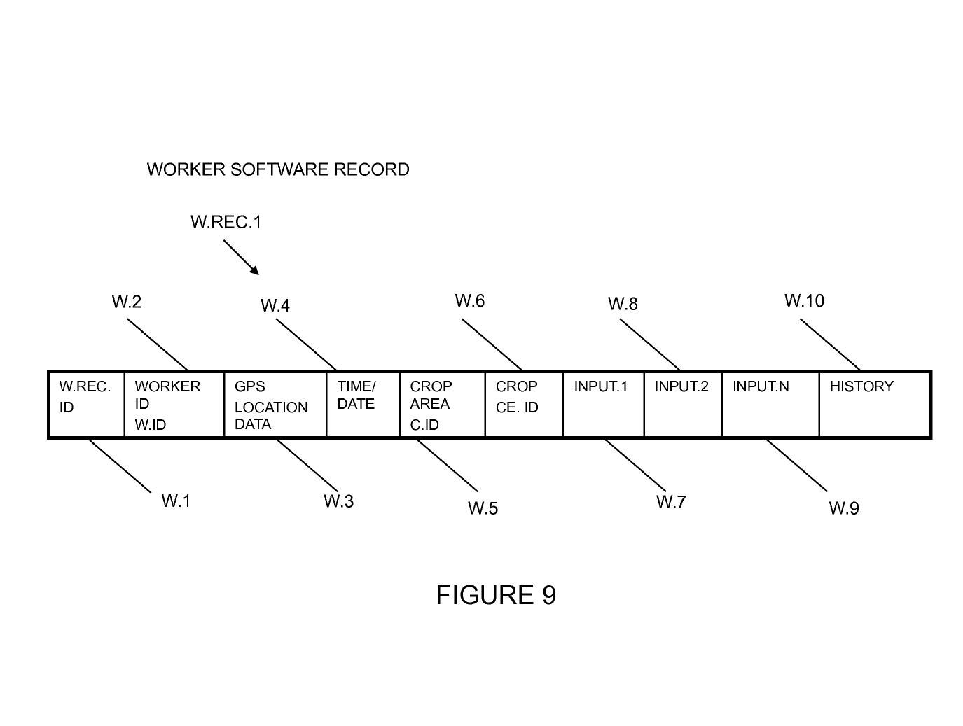

FIG. 9 is an illustration of an exemplary first worker record W.REC.001 that includes a worker identifier W.ID and information INPUT.1-INPUT.N related to a particular and exemplary worker 4 associated with the worker identifier W.ID. The Worker identifier W.ID may be, comprise, or be associable with a government issued immigration service identifier and/or tax identifier, such as a social security account number. issued and crop area(s) and crop element(s) of FIGS. 1, 4 and 7. The information for each of the worker record data fields W.1-W.10 of the each worker record W.REC.001-W.REC.N may be entered into the comprising worker record W.REC.001-W.REC.N by means of manual input into the GPS device 2, the GIS server 24, the database server 26, the network computer 28, or the RFID reader/writer 32 in combination or in singular.

The process of FIG. 6 may be applied to generate and update a worker record wherein an individual worker 4 is identified in step 6.2. A worker record identifier R.1 is assigned or received and an exemplary first worker record W.REC.001 is formed in step 6.4. The first worker record W.REC.001 is then instantiated in step 6.6 and the worker record identifier W.ID of step 6.4 and a worker identifier W.ID associated with the worker 4 selected in step 6.2 is written into the exemplary first worker record W.REC.001.

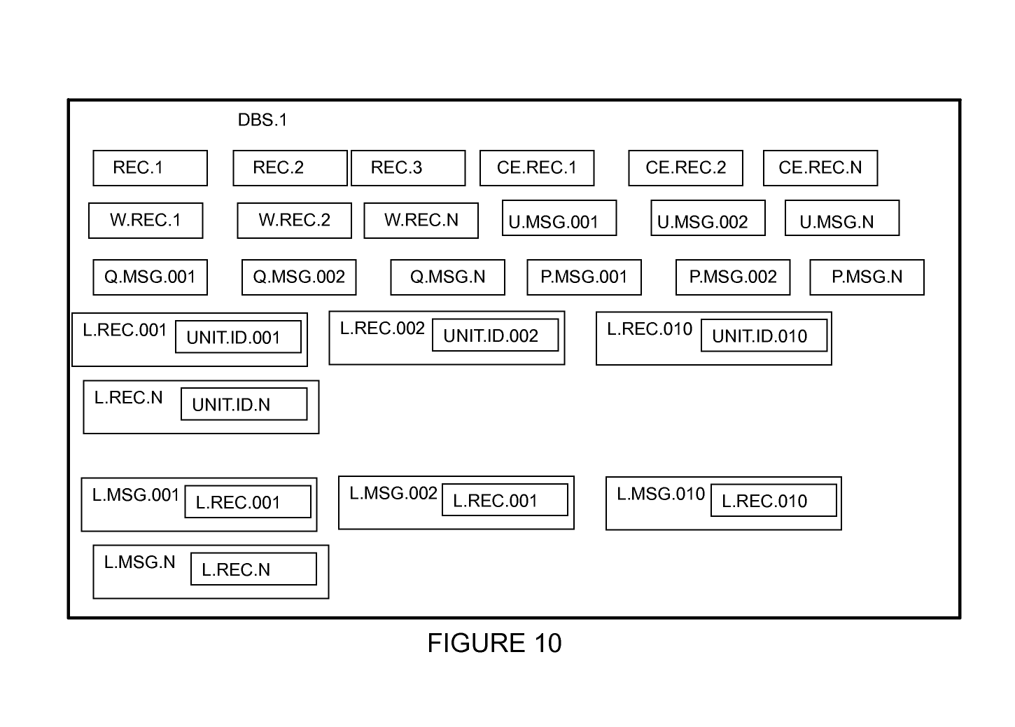

One or more worker records W.REC.001-W.REC.N may then be stored and updated with information of worker record data fields W.1-W.10, wherein the information may be generated by and/or received by and/or stored in whole or in part in information technology systems communicatively coupled with the Internet 22 and/or or one or more GPS devices 2, communications networks 20, telephony networks 30, one or more GPS devices 2, GIS servers 24, database servers 26, network computers 28, and RFID writers/readers 32 in combination or in singularity. A bar code record 20 may further be generated to store and display patterned information that identifies and/or is related to the worker 4 identified by the worker identifier W.ID. FIG. 10 is an illustration of the exemplary database DBS.1 of FIG. 2 that may be stored in the GPS device 2, computer or server of FIG. 1, 2, or 3 and comprising information partially or entirely of records REC.001-REC.N, CE.REC.001-CE.N &W.REC.001-W.REC.N of FIGS. 2, 4, 7 and 9.

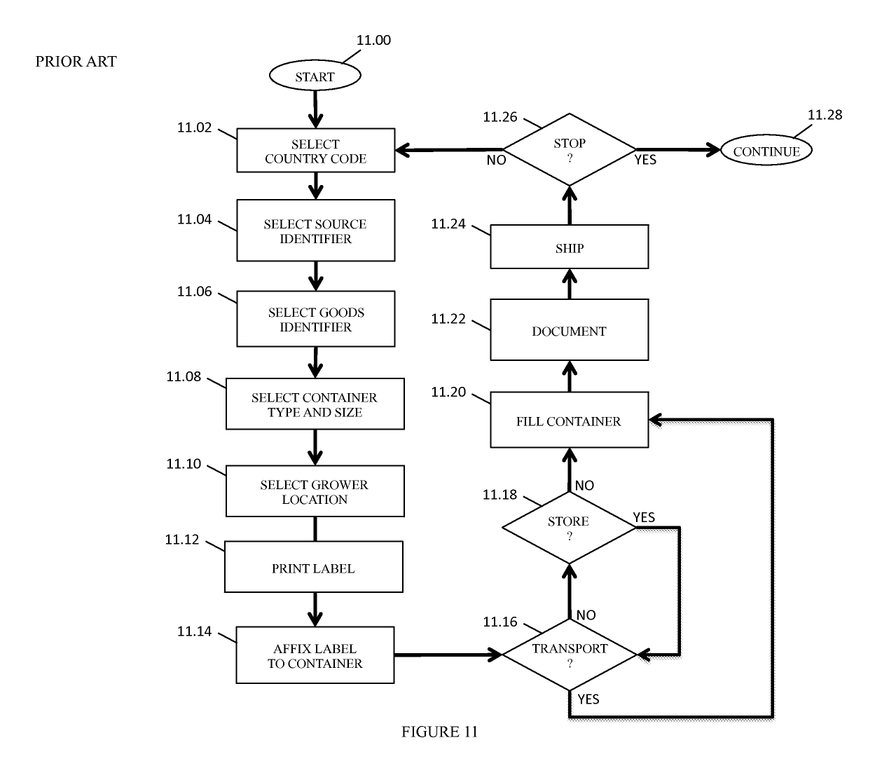

FIG. 11 is a process chart of prior art preparation, printing and use of the prior art label LBL.PRI in association with an individual container 18A-18N. In step 11.02 a country code CC.ID identifying a source nation of an individual unique product unit 14A-14B of the crop element 14 associated with a particular container 18A-18N, e.g., an association of the first product unit 14A with the exemplary first container 18A. In step 11.04 a source identifier SOU.ID is selected that identifies a firm, association, person or brand name that is held as the legally responsible and/or de facto source of the crop element 14. In step 11.06 a goods identifier GDS.ID is selected that identifies a type applicable to the first product unit 14A. In step 11.08 a container type CON.TYP and/or container size CON.SIZ descriptive of the first container 14A is selected. In step 11.10 a source location identifier SOU.LOC that identifies a geographic location at which the crop element 14 is substantively grown or produced is selected.

In step 11.12 the prior art label is printed wherein the country code CC.ID, the source identifier SOU.ID, the goods identifier GDS.ID, the container type CON.TYP, the container size CON.SIZ and/or the source location identifier SOU.LOC are printed onto label stock LBL.STK to generate the prior art label LBL.PRI. This printing of step 11.12 preferably includes redundant representation wherein some or all of the information selected in steps 11.02 through 11.10 may be represented in both human readable form and machine-readable bar code imaging.

In step 11.14 the prior art label LBL.PRI is affixed to the first container 18A and the first container 18A may be alternatively transported in step 11.16 and stored in step 11.18. The first product unit 14A of the crop element is preferably substantively positioned with the first container 18A and this action of step 11.22 may be documented in step 11.24. The first container 18A is then shipped into and within the stream of commerce in step 11.24, and a determination is made in step 11.26 whether to repeat an execution of steps 11.02 through 11.24 or to proceed on to alternate actions of step 11.28.

A particular weakness of the prior art method of FIG. 11 lies in the danger of affixing the prior art label LBL.PRI to a container 18A-18N that does conform in some way to the information visually displayed by the prior art label LBL.PRI. In the prior art, all to often after the performance of step 11.22 it is determined that the information presented in the prior art label LBL.PRI does not accurately describe one or more valid attributes of the first product unit 14A, i.e., an inaccuracy may be expressed by the printing of the source identifier SOU.ID, the goods identifier GDS.ID, the container type CON.TYP, the container size CON.SIZ and/or the source location identifier SOU.LOC in step 11.12.

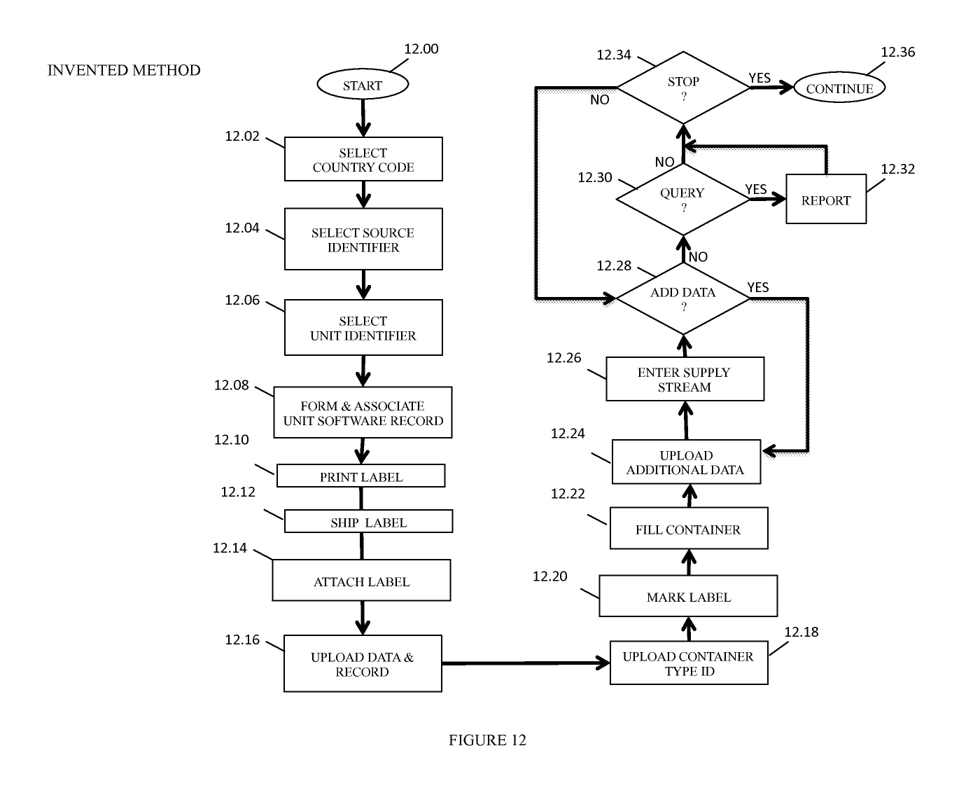

FIG. 12 is a flow chart depicting a first aspect of the invented method for associating a product unit with a shipping container 18A-18N. In step 12.02 the country code CC.ID identifying the source nation of an individual unique product unit 14A-14B of the crop element 14 associated with a particular container 18A-18N, e.g., an association of the first product unit 14A with the exemplary first container 18A. In step 12.04 the source identifier SOU.ID is selected that identifies a firm, association, person or brand name that is held as the legally responsible and/or de facto source of the crop element 14. In step 12.06 an exemplary first unit identifier UNIT.ID.001 is selected. In step 12.08 an exemplary first label software record L.REC.001 is formed and populated with the country code CC.ID, the source identifier SOU.ID and the first unit identifier UNIT.ID.001 selected in steps 12.02 through 12.06.

In step 12.10 the country code CC.ID, the source identifier SOU.ID and the first unit identifier UNIT.ID.001 are printed on a label stock LBL.STK to generate an exemplary first invented label LBL.001, wherein some or all of the information printed onto the label stock LBL.STK may be expressed as a machine-readable bar code image.

The label stock LBL.STK may be selected from a plurality of readily available brands and sizes. The area dimensions of label stock LBL.STK placed upon containers such as individual containers 18A-18B are determined by individual distributors, or by governmental requirements. Illustrative, but not limiting, examples of possible label stock LBL.STK dimensions are substantively rectangular labels having orthogonal dimensions of 3″ by 1.5″, 3″ by 2″, 4″ by 2″ or 4″ by 2.5″. Other suitable adhesive label stock LBL.STK known in the art may be selected in accordance with the invented method, such as, but not limited to, Part Number 5126 Avery™ White Internet Shipping Labels for Laser Printers 5126, having orthogonal dimensions of 5½″×8½ as marketed by Avery Products Corporation of 50 Pointe Drive, Brea, Calif. 92821; or Avery™ Permanent Shipping Labels Part Number 05286 having orthogonal dimensions of 3″×4 as marketed by Avery Products Corporation of 50 Pointe Drive Brea, Calif. 92821; or other suitable labels known in the art.

The first invented label LBL.001 may be shipped to a work site in step 12.12 and attached to an individual container 18A-18B in step 12.14. Additional data relating to the first product unit 14A and/or the first container 18A may be uploaded via the network 20 in step 12.16 and stored into the first label software record L.REC.001. More particularly, the container type identifier CON.TYP applicable to and/or descriptive of the first container 18A may be uploaded via the network 20 in step 12.18 and stored into the first label software record L.REC.001 in step 12.16.

A worker or other party in step 12.20 may add representations of information to the first invented label LBL.001, by of, for example and not limited to, stamps 1400-1404, a marking pen 1406 and/or the programmable handheld printer 38. The first product unit 14A is substantively positioned within, or in spatial relation to, the first container 18A in step 12.22. In optional step 12.24 additional data, such as time-date stamps and GPS data relating to the progress of the first product unit 14A through the stream of commerce may be uploaded via the network 20 and stored into the first label software record L.REC.001 and thereby be associated with the first product unit 14A.

The first product unit 14A is released into, or continues to proceed, within the stream of commerce in step 12.26.

In step 12.28 a determination is made whether to proceed to step 12.24 and upload additional data into the first label software record L.REC.001 or to proceed to step 12.30. In step 12.30 a determination is made as to whether a query has been received from the first label software record L.REC.001. When a query is received in 12.30, a report is generated and transmitted in step 12.32. The method proceeds either from step 12.30 or step 12.32 to step 12.34. A determination is made in step 12.34 whether to repeat an execution of steps 12.28 through 12.34 or to proceed on to alternate actions of step 12.36.

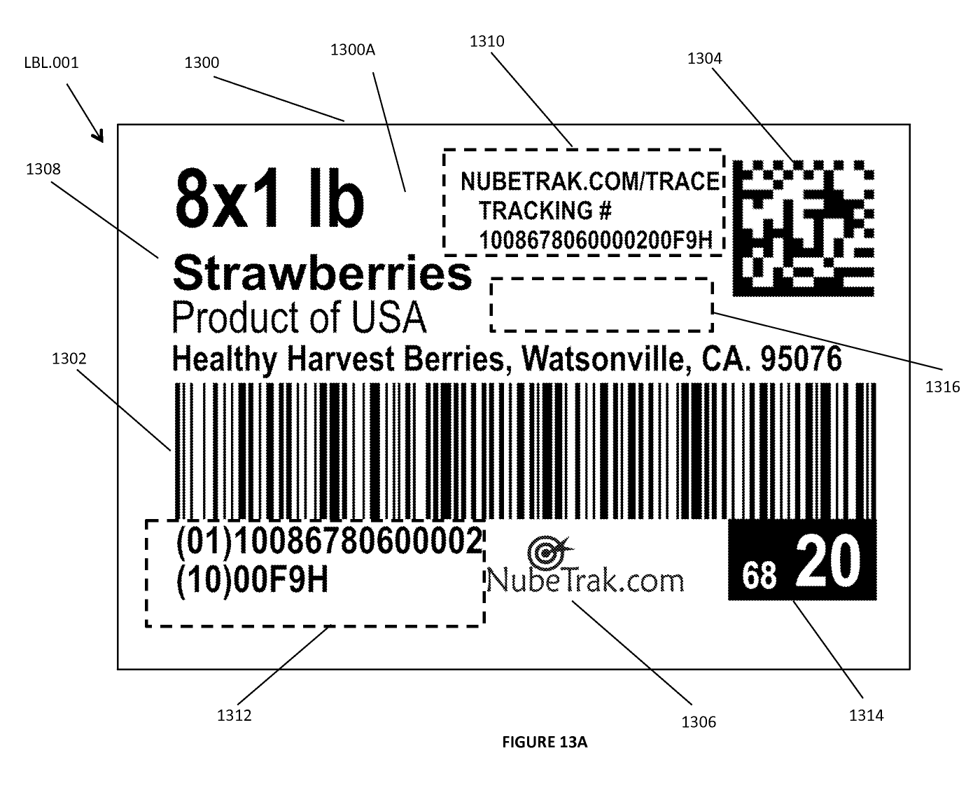

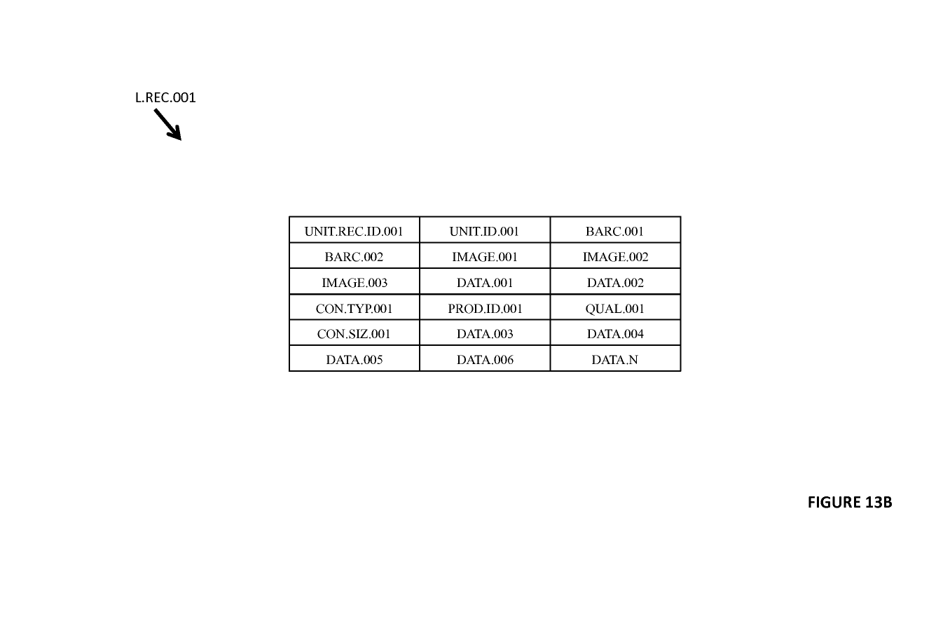

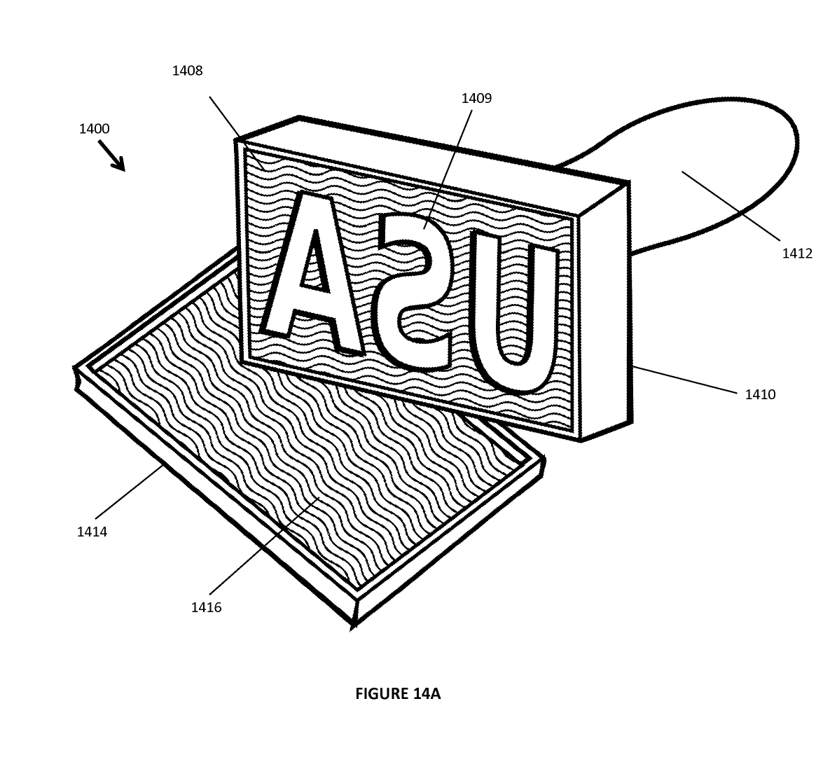

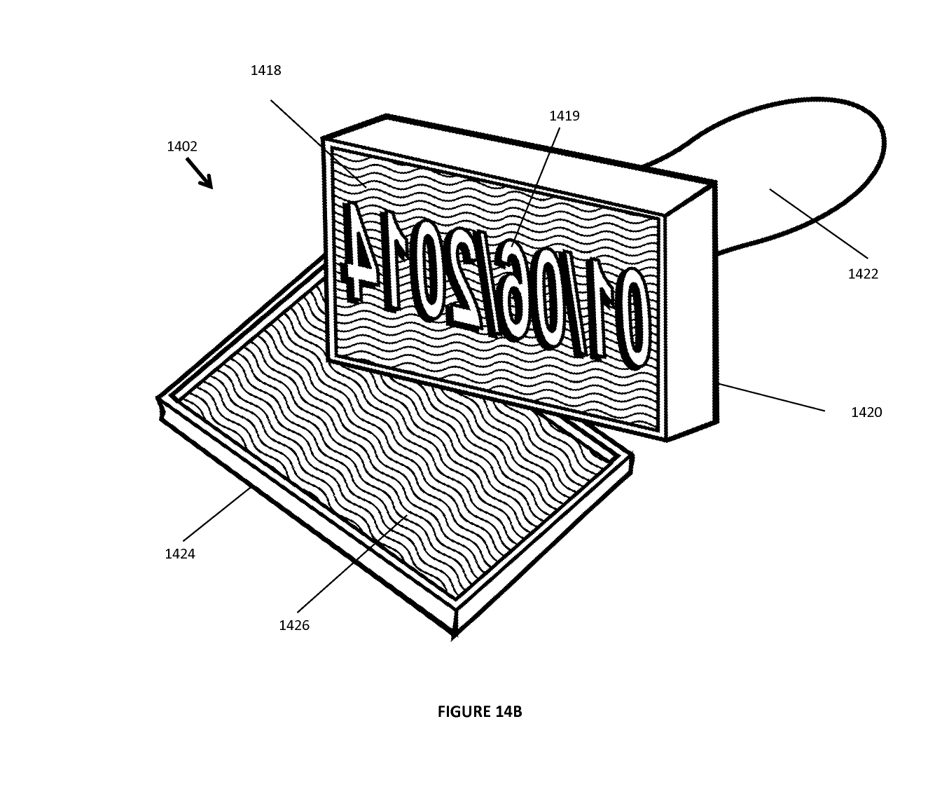

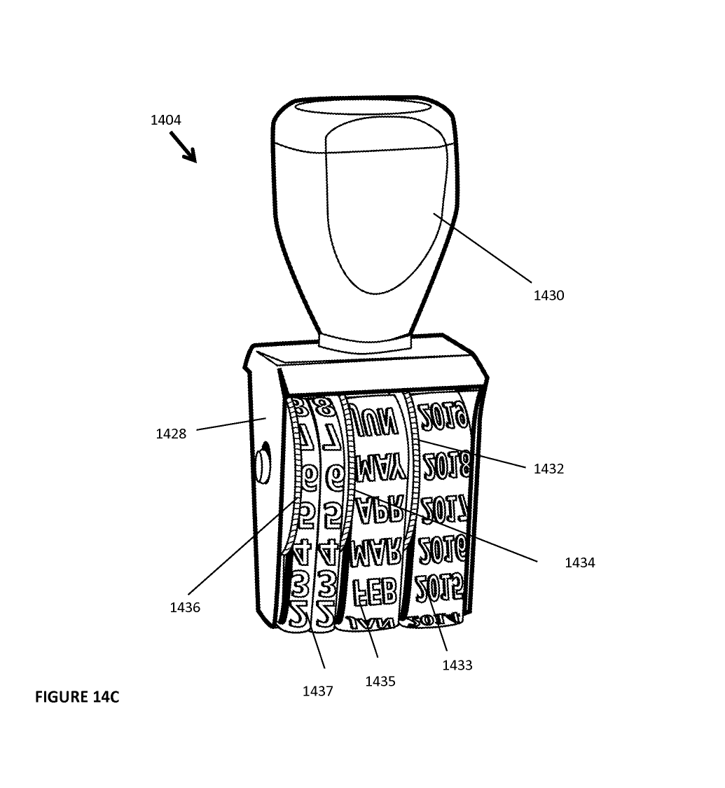

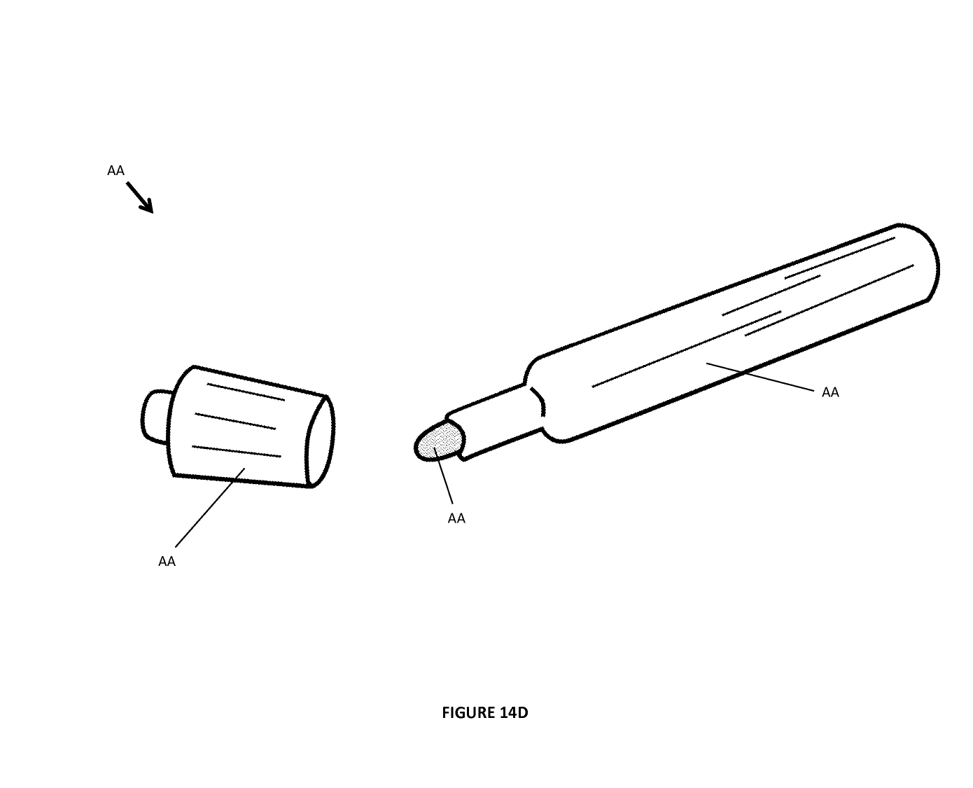

FIG. 13A is an illustration of the exemplary first invented label LBL.001 (hereinafter, “the first label” LBL.001). The first label LBL.001 includes a label stock paper 1300 having an external face side 1300A upon which are visually presented (a.) human-readable text and images, and (b.) machine-readable bar code images. In particular, the first label LBL.001 visually presents a first bar code image 1302 and a two-dimensional bar code image 1304 are printed on the label stock paper 1300, in addition to a source logo image 1306, a first information image 1308, a first unit identifier text 1310, a second unit identifier text 1312, and a parameter block image 1314. A pick date area 1316 is provided wherein a date of picking of the first product unit 14A contained within the first container 18A may be added by means of programmable handheld printer 38, the manual stamps 1400, 1402, and 1404 and/or the manual marking pen 1406 of FIGS. 14A-14D

FIG. 13B is a block diagram of an exemplary first software label record L.REC.001 that is identified by a first label record identifier UNIT.REC.ID.001 and is associated with the first label LBL.001 by reference to a first unique unit serial number UNIT.ID.001 (hereinafter, “the first unit identifier” UNIT.ID.001) stored within the first software label record L.REC.001 (hereinafter, “the first label record” L.REC.001). It is thereby understood that the first unit identifier UNIT.ID.001 value of (10)00F9H is stored within the first software label record L.REC.001.

The first label record L.REC.001 further includes a first barcode data BARC.001 that contains the information presented in the first barcode 1302. The first label record L.REC.001 also includes a second barcode data BARC.002 that contains the information presented in the two-dimensional barcode 1304. Further included in the first label record L.REC.001 is a first image data IMAGE.001 that contains image data rendered as the first source logo image 1306. The first label record L.REC.001 additionally includes a second image data IMAGE.002 which contains image data printed in the first information image 1308. The first label record L.REC.001 further includes a first alphanumeric datum DATA.001 that contains the first unit identifier text 1310. Also included in the first label record L.REC.001 is a second alphanumeric datum DATA.002, which contains information represented by the second unit identifier text 1312. The first barcode data BARC.001, the second bar code data BARC.002, the first alphanumeric datum DATA.001 and/or the second alphanumeric datum DATA.002 may redundantly include, and when rendered display, (a.) the first unit identifier UNIT.ID.001 value of (10)00F9H and/or (b.) a source identifier data value (01)10086780600002 that is provided by a third party source registration and identification provider such as Global Trade Item Number (or “GTIN”™) as issued by GS1 of Lawrenceville, N.J. In addition, the second image data IMAGE.002 that is rendered as the first information image 1308 may optionally include, and when rendered display, a human-readable visual representation of the (a.) the first unit identifier UNIT.ID.001 value of (10)00F9H and/or (b.) a source identifier data value (01) 10086780600002.

The first label record L.REC.001 further contains a third image data IMAGE.003 which contains image data that is rendered as the parameter block image 1314.

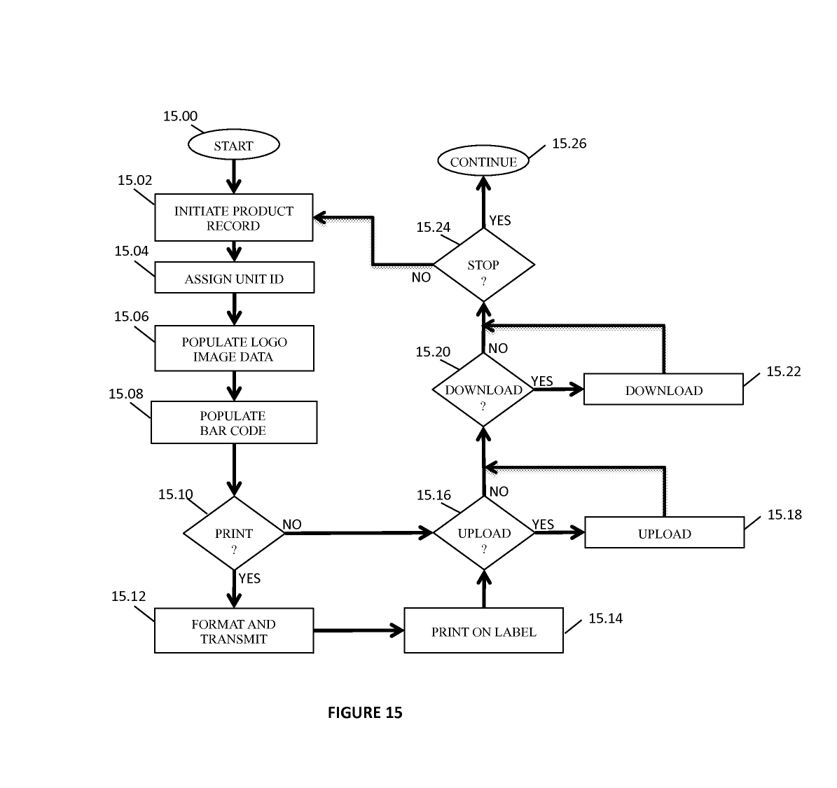

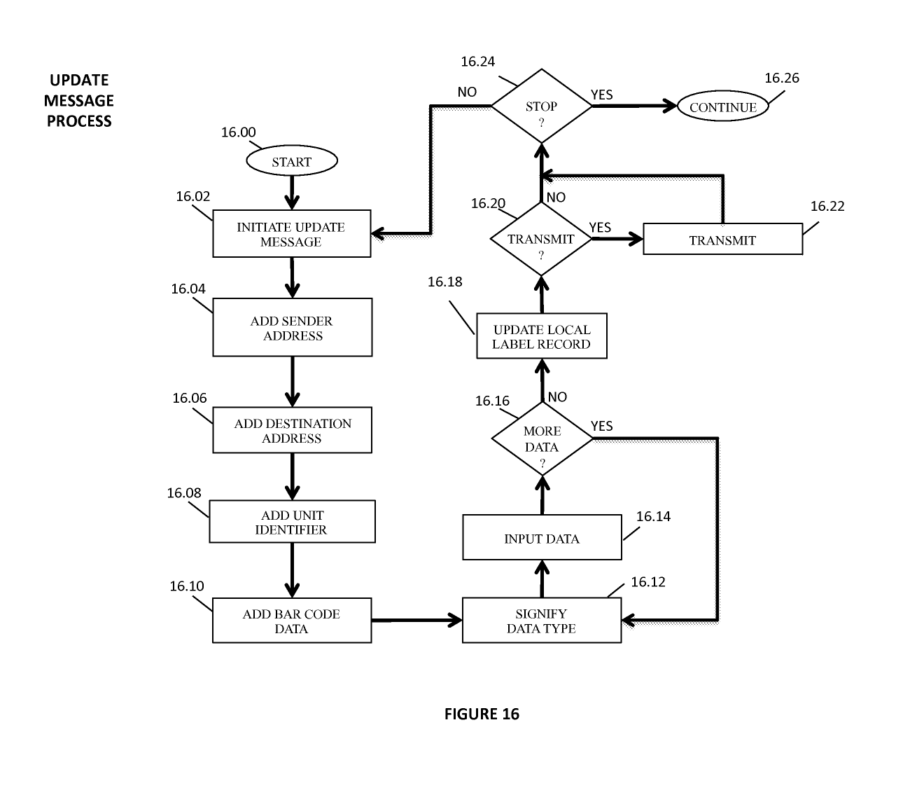

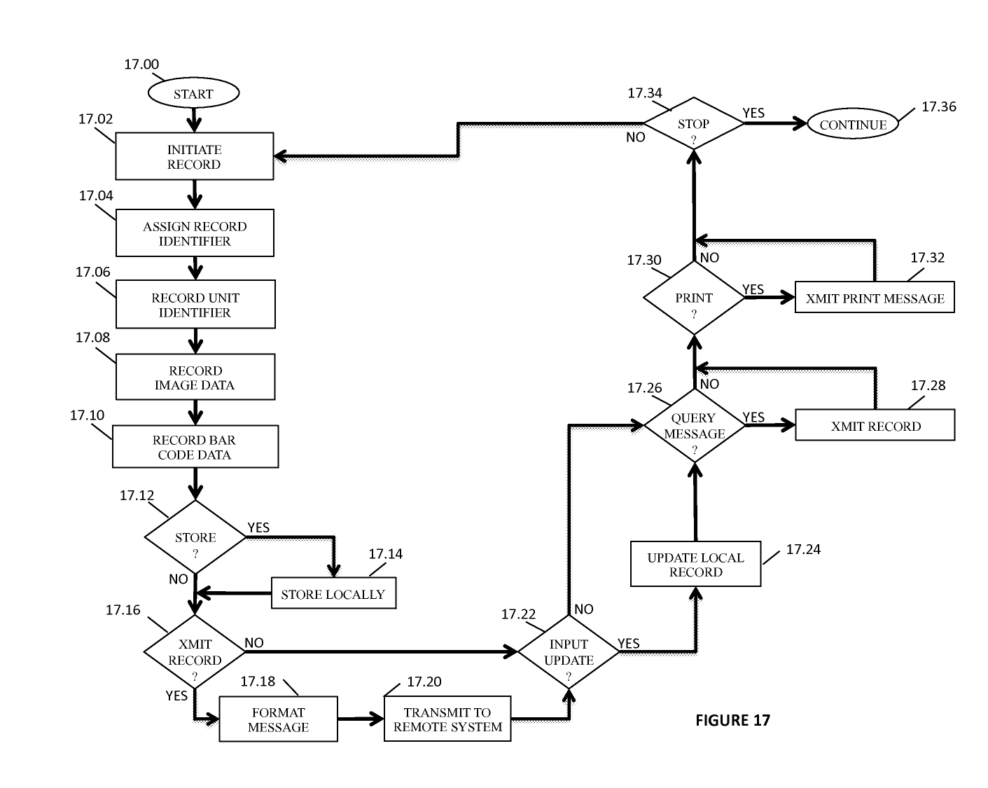

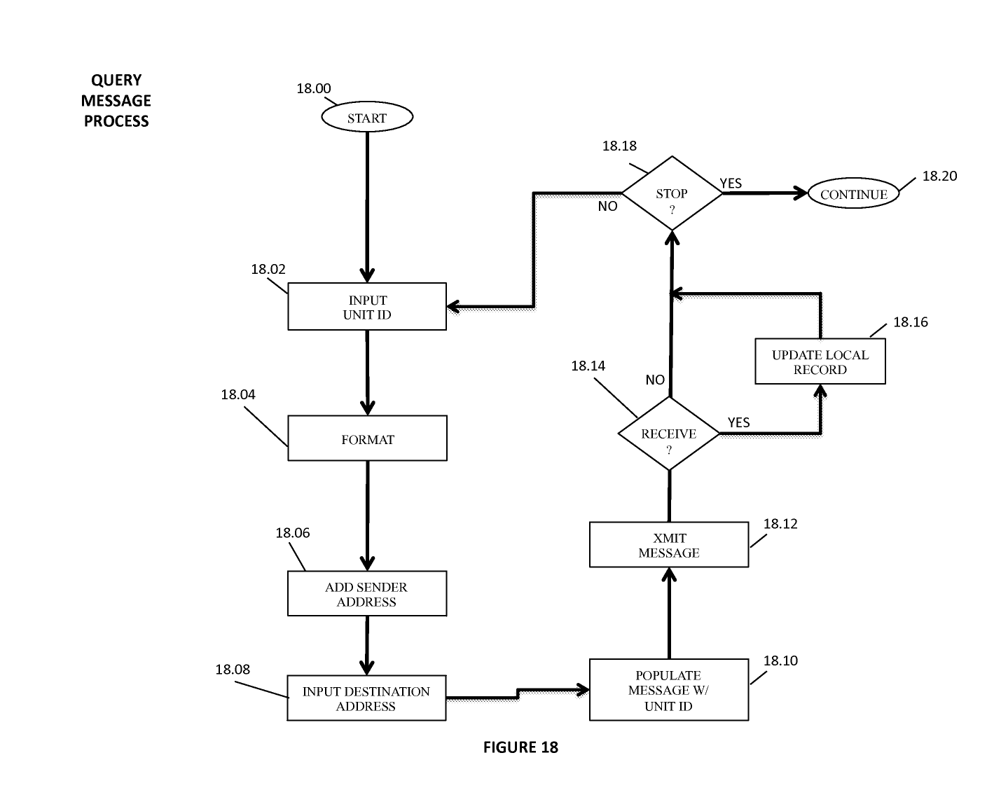

Optionally, additionally or alternatively, the first label record L.REC.001 may include a container type designation CON.TYP.001, a container size designator CON.SIZ.001, a product type value PROD.001, and/or one or more alphanumeric, barcode or image data DATA.003-DATA.N. It is understood that one or more data values DATA.001-DATA.N, IMAGE.001-IMAGE.003 & BARC.001-BARC.002 may be added to or revised within the first label record L.REC.001 in an execution of (a.) step 12.16, 12.18, and/or 12.14 of the method of FIG. 12. (b.) step 15.04, 15.06, 15.08, 15.18, and/or 15.22 of the method of FIG. 15, (c.) step 16.10 and/or 16.18 of the method of FIG. 16, (d.) 17.08, 17.10, 17.12, 17.14, and/or 17.24 of the method of FIG. 17, and (e.) step 18.16 of the method of FIG. 18.

Referring now generally the Figures and particularly to FIGS. 14A-14D, four instruments that may separately be used to mark the first label LBL.001 are presented. Referring now to FIG. 14A, a first stamp 1400 is used to mark a nation of origin indicator on the first label LBL.001. The first tamp 1400 comprises a first stamping surface 1408 that defines a country indication shape 1409 that indicates a country of origin. The first stamping surface 1408 is set within a first stamp frame 1410. A first handle 1412 of the first stamp 1400 is attached to a back of the first stamp frame 1410. A first ink housing 1414 contains a first well of ink 1416 that is used to supply wet ink to the first stamp 1408 to enable stamping an ink image of the country indication shape 1409 onto the first label LBL.001.

Referring now to FIG. 14B, a second stamp 1402 is used to mark a date indicator image onto the first label LBL.001. The second stamp 1402 includes a second stamp surface 1418 that includes a date shape 1419 that specifies a particular calendar date. The second stamp surface 1418 is set within a second stamp frame 1420. A second handle 1422 of the second stamp 1402 is attached to a back of the second stamp frame 1420. A second ink housing 1424 contains a second well of ink 1426 that is used to supply wet ink to the second stamp 1418 to enable stamping an ink image of the date shape 1419 onto the first label LBL.001.

Referring now to FIG. 14C, a third stamp 1404 that may be used to mark the first label LBL.001 with a selectable date indication mark. The third stamp 1404 includes a third stamp frame 1428. Attached to a top of the third stamp frame 1428 is a third stamp handle 1430 that enabled manual positioning and application of the third stamp 1404 to ink-stamp dates onto the labels LBL.001-LBL.N, e.g., the first label LBL.001. Within the third stamp frame 1428, a first moving gear 1432 allows the user to select a year value from a year value stamp strip 1433 to be stamped onto the first label LBL.001. A second moving gear 1434 allows the user to select a month value from a month value stamp strip 1435 to be stamped onto the first label LBL.001. The third moving gear 1436 allows the user to select a numeric date value from a month value stamp strip 1435 to be stamped in ink onto the first label LBL.001. The user may thus select a date indication on a stamp surface 1436 by manually manipulating the moving gear 1432, the second moving gear 1434, and the third moving gear 1436 in order to stamp a selected year, month and day date value onto the first label LBL.001.

Referring now to FIG. 14D, a marker 1406 that may be used to manually mark the first label LBL.001. The marker 1406 includes a handle 1438. The handle 1438 surrounds a felt tip 1440 that may be used to manually mark first label LBL.001 in ink. A removable cap 1442 may be attached to the handle 1438 over the top of the felt tip 1440 in order to keep the felt tip 1440 damp for further use.

Referring now generally the Figures and particularly to FIG. 15, FIG. 15 is a software flowchart of aspects of the invented method that may be implemented by one or more servers 26, computers 28 or GPS devices 2 of the network 20, wherein a particular product unit 14A-14N is associated with a software record L.REC.001-L.REC.N, and information from the selected and associated software record L.REC.001-L.REC.N is associated with an invented label LBL.001-LBL.N that is attached to a container 18A-18N and/or coupled with a product unit 14A-14N.

For the purposes of illustration, and not offered as a limitation, the steps and aspects of the process of FIG. 15 will be discussed as being executed by the GPS device 2, whereas it is understood that one or more or all of the steps and aspects of the process of FIG. 15 may be implemented by one or more alternate servers 26, computers 28 or GPS devices 2 in singularity or in combination.

In step 15.02 a label record L.REC.001-L.REC.N having a unique label record identifier UNIT.REC.ID.001-UNIT.REC.N is initiated and a unit identifier UNIT.ID.001-UNIT.N is assigned in in step 15.04. For the purposes of illustration, and not offered as a limitation, the steps and aspects of the process of FIG. 15 will be discussed as being directed toward the first exemplary label record L.REC.001 having the first unit record identifier L.REC.ID.001 and populated in step 15.04 with a first unit identifier UNIT.ID.001. In step 15.06 the first logo data LOGO.001 is written into the first label record L.REC.001, wherein the first logo data LOGO.001 contains image data that may be rendered by one or more printers 34, 36 & 38 to visually present the source logo image 1306. In step 15.08 bar code data BARC.001 & BARC.002 is written into the first label record L.REC.001, wherein the bar code contains alphanumeric data that may be rendered by one or more printers 34, 36 & 38 to visually present the barcode images 1302 & 1304 of the first label LBL.001.

In step 15.10 a determination is made whether a command has been received to initiate a print action wherein the first label LBL.001 shall be printed. In step 15.12 the GPS device formats and transmits an exemplary first print message PMSG.001 that is addressed to a printer 34, 36 & 38 and contains data (a.) formatted by a selected printer driver PDR.01 & PDR.02 to enable the printer 34 & 36 addressed by the message to either print onto label stock 1300 to generate the invented label LBL.001; or (b.) formatted by the programmable handheld printer driver PDR.03 to enable the programmable handheld printer 38 to apply ink images 1302-1314 onto the first container 18A. In optional step 15.14 the GPS device 2 issues a command to (a.) the printer 34 & 36 addressed in step 15.12 to print the first invented label LBL.001 and/or (b.) alternatively or additionally direct the programmable handheld printer 38 to image by application of the images 1302-1314 rendered from the first label record LBL.001.

In step 15.16 the GPS device 2 determines whether a command has been received to upload the first label record LBL.REC.001 via the network 20 to another device 2, server 24 & 26 and/or computer 28. When the GPS device 2 determines in step 15.116 that a command has been received to upload the first label record LBL.REC.001, the GPS device 2 executes this command and transmits the first label record LBL.REC.001 via the network 20 in step 15.18.

In step 15.20 the GPS device 2 determines whether a command has been received to accept additional information to be written into the first label record LBL.REC.001, optionally by either access to a computer-product memory device or via the network 20 from another device 2, server 24 & 26 and/or computer 28. When the GPS device 2 determines in step 15.16 that a command has been received to accept and write additional information into the first label record LBL.REC.001, the GPS device 2 executes this command in step 15.22.

The instant GPS device 2 determines in step 15.24 whether to proceed back through an additional execution of the loop of steps 15.10 through 15.24, or whether to proceed on to alternate computational process of step 15.26. It is understood that the GPS device 2 may proceed from step 15.26 to an additional execution of step 15.02 and to generate, populate, disseminate and update one or more label records LBL.001-LBL.N.

Referring now generally the Figures and particularly to FIG. 16, FIG. 16 is a software flowchart that may be implemented within the communications network 20, wherein a label record LBL.REC.001-LBL.REC.N is updated as directed in step 15.18 of the FIG. 15.

For the purposes of illustration, and not offered as a limitation, the steps and aspects of the process of FIG. 16 will be discussed as being executed by the GPS device 2, whereas it is understood that one or more or all of the steps and aspects of the process of FIG. 16 may be implemented by one or more alternate servers 24 & 26, computers 28 or GPS devices 2 in singularity or in combination.

In step 16.02 the GPS device 2 initiates an exemplary first update message U.MSG.001 that incudes a unique first update message identifier U.MSG.ID.001 and the network address of the GPS device 2 is added as the sender address SND.ADDR.001 in step 16.04. In step 16.06 a destination address DEST.ADDR.001 is added to the first update message U.MSG.001, a unit identifier UNIT.ID.001-UNIT.ID.N of a label record LBL.REC.001-LBL.N is added to the first update message U.MSG.001.

In optional step 16.10 additional barcode data BARC.001 & BARC.002 is added to the first update message U.MSG.001. In optional step 16.12 a type is input into the GPS device 2 and in step 16.14 data signified by the data type indicated in step 16.12 is entered into the first update message U.MSG.001. In step 16.16 the GPS device 2 determines whether it is directed by either a user or the system software SW.8 to input additional information in an additional execution of steps 16.12 and 16.14. In step 16.16 the GPS device 2 determines whether it is directed by either a user or the system software SW.8 to transmit the first update message U.MSG.001 in step 16.18. The GPS device 2 transmits the first update message U.MSG.001 in step 16.20.

The GPS device 2 determines in step 16.22 whether to proceed back through an additional execution of the loop of steps 16.02 through 16.20, or whether to proceed on to alternate computational process of step 16.24. It is understood that the GPS device 2 may proceed from step 16.24 to an additional execution of step 16.02 and to generate an additional update message to update the informational contents of one or more label records L.REC.001-L.REC.N.

Referring now generally to the Figures and particularly to FIG. 17, FIG. 17 is a software flowchart of additional aspects of the invented method that may be implemented by one or more systems 24, 26 & 28 or GPS devices 2 of the communications network 20, wherein a particular product unit 14A-14N is associated with a label record L.REC.001-L.REC.N, and information from an individual label record L.REC.001-L.REC.N is associated with a label LBL.001-LBL.N attached to or coupled with a product unit 14A-14N.

For the purposes of illustration, and not offered as a limitation, the steps and aspects of the process of FIG. 17 will be discussed as being executed by the GPS device 2, whereas it is understood that one or more or all of the steps and aspects of the process of FIG. 17 may be implemented by one or more alternate servers 24 & 26, computers 28 or GPS devices 2 in singularity or in combination.

In step 17.02 the GPS device 2 initiates an exemplary label record L.REC.001. In step 17.04 the GPS device 2 assigns an exemplary unique record identifier UNIT.REC.ID.001 to the first label record L.REC.001. In step 17.06 the unique label record identifier UNIT.REC.ID.001 is recorded into the first label record L.REC.001 by the GPS device 2, whereby the unique label record identifier UNIT.REC.ID.001 and first label record L.REC.001 may be stored locally within the GPS device 2 or transmitted via the communication network 20 to a remote system, server and or computer 24, 26 & 28. In optional step 17.08 the GPS device 2 writes one or more image data LOGO.001, IMAGE.001-IMAGE.003 into the first label record L.REC.001. The GPS device 2 in optional step 17.10 writes one or more the barcode data BARC.001 & BARC.002 into the first label record L.REC.001.

In step 17.12 the GPS device 2 optionally determines whether to locally store the first label record L.REC.001 with the data recorded in steps 17.06-17.10 locally within the GPS device 2. If the GPS device 2 determines to store the data contained within the first label record L.REC.001, the data is stored locally in step 17.14. The GPS device 2 additionally optionally determines whether to transmit the first label record L.REC.001 to a server 24 & 26, computer 28 or additional GPS devices 2 in step 17.16. If the determination in step 17.16 is affirmative, the GPS device 2 formats the first label record L.REC.001 for transmission in step 17.18, and transmits an exemplary first label message L.MSG.001 in step 17.20 that includes the first label record L.REC.001 in whole or in part.

The GPS device 2 proceeds either from step 17.20 or from step 17.16 to step 17.22, wherein the GPS device 2 determines whether to input an additional update data DATA.003-DATA.N to the first label record L.REC.001. The GPS device 2 updates the local label record L.REC.001 in step 17.24 with update data detected in step 17.22. In step 17.26 the GPS device 2 determines whether a first query message Q.MSG.001 has been received that requests transmission of the first label record L.REC.001. When the GPS device 2 detects receipt of the first query message Q.MSG.001 from a requesting remote server GPS device 1, computer 28 or server 24 & 26, the first label record L.REC.001 is transmitted to the requesting remote system 2, 24, 26 & 28.

The GPS system 2 proceeds either from step 17.26 or from step 17.28 to step 17.30, wherein the GPS device 2 determines whether a command has been received to print some or all of the contents of the first label record L.REC.001 onto the label stock 1300 to form the first label LBL.001 by means of the printer 34, or the printer 36, and/or partially image some or all of the contents of the first label record L.REC.001 onto the first container 18A by application of the programmable handheld printer 38. If the determination in step 17.30 is positive, an exemplary first print message P.MSG.001 is transmitted by the GPS device 2 to the printer 34, the printer 36, and/or the programmable handheld printer 38 in step 17.32. It is understood that the payload of first print message P.MSG.001 may have been generated by application of a printer driver PDR.01-PDR.03 to the information of the first label record L.REC.001.

The instant GPS device 2 determines in step 17.34 whether to proceed back through an additional execution of the loop of steps 17.02 through 17.34, or whether to proceed on to alternate computational process of step 17.36. It is understood that the GPS device 2 may proceed from step 17.36 to an additional execution of step 17.02 and to generate, populate, disseminate and update one or more label records LBL.001-LBL.N.

Referring now generally the Figures and particularly to FIG. 18, FIG. 18 is a software flowchart of aspects of the invented method that may be implemented by one or more GPS devices 2, computers 28 or servers 26 of a query message process.

For the purposes of illustration, and not offered as a limitation, the steps and aspects of the process of FIG. 18 will be discussed as being executed by the GPS device 2, whereas it is understood that one or more or all of the steps and aspects of the process of FIG. 18 may be implemented by one or more alternate servers 26, computers 28 or GPS devices 2 in singularity or in combination.

In step 18.02 the GPS device receives and input of an exemplary unit identifier UNIT.ID.001-UNIT.N, for example the first unit identifier UNIT.ID.001, for insertion an exemplary first query message Q.MSG.001 and generates and formats the first query message Q.MSG.001 in step 18.04. In step 18.06 the GPS device 2 adds the network address of the first GPS device 2 as the sender address SND.ADDR.001 and inputs a second destination address DEST.ADDR.002 in step 18.08, wherein the second destination address DEST.ADDR.002 is a network address of a system, computer, device or server 2, 24, 26 & 28 that stores or has access to label records L.REC.001-L.REC.N. The first query message Q.MSG.001 is populated with a unit identifier UNIT.ID.001-UNIT.N, for example the first unit identifier UNIT.ID.001, by the GPS device 2 in step 18.10 and the query message Q.MSG.001 is transmitted in step 18.12 via the network 20. In step 18.14 the GPS device 2 makes a determination whether a exemplary first responding label record message L.MSG.001 has been received, wherein the first responding label record message L.MSG.001 preferably includes the label record L.REC.001-L.REC.N associated with the unit identifier UNIT.ID.001-UNIT.N included in the first query message Q.MSG.001.

When the GPS device 2 determines that the GPS device 2 has a valid responding label record message L.MSG.001-L.MSG.N in step 18.14, the GPS device 2 updates the local record L.REC.001-L.REC.N associated with the unit identifier UNIT.ID.001-UNIT.N of the received responding label record message L.MSG.001-L.MSG.N in step 18.16. Alternatively, if the GPS device 2 determines that no valid responding label record message L.MSG.001-L.MSG.N has been received by the GPS device 2 in step 18.14, the GPS device proceeds from step 18.14 to step 18.18. The GPS device 2 proceeds from either 18.14 or step 18.14 to step 18.18 and determines whether to proceed to step 18.02 to execute an additional loop of steps 18.02 through 18.18, or whether to proceed on to step 18.20 to continue other operations.

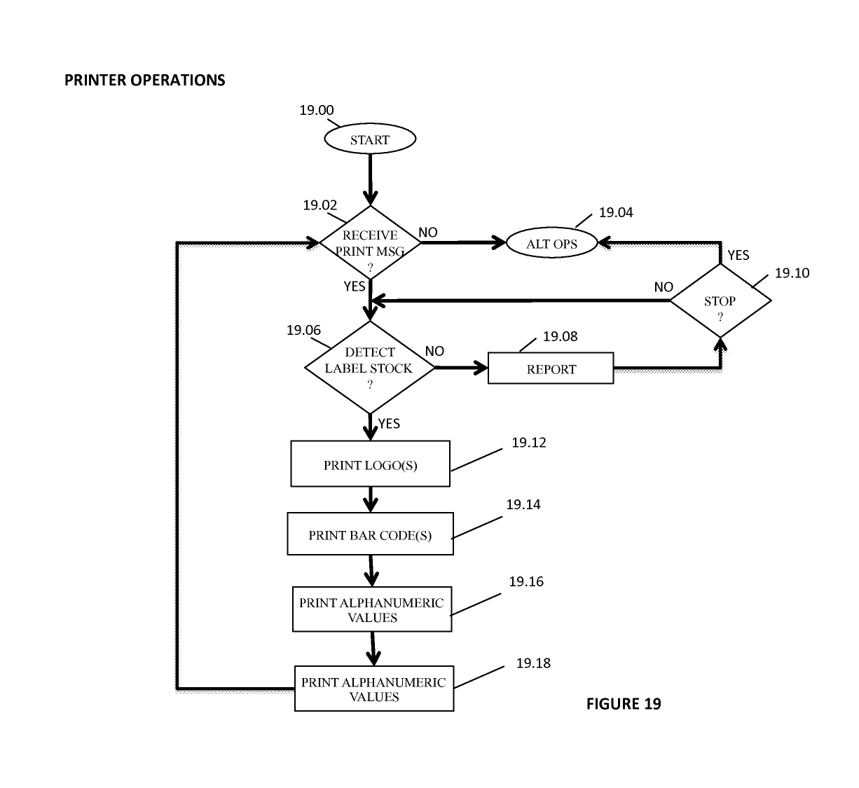

Referring now generally to the Figures and particularly to FIG. 19, FIG. 19 is a software flowchart of aspects of the invented method that may be implemented by one or more mobile printers 36, printers 34 or programmable handheld printer 38 of the Internet 22.

For the purposes of illustration, and not offered as a limitation, the steps and aspects of the process of FIG. 19 will be discussed as being executed by a mobile printer 26, whereas it is understood that one or more or all of the steps and aspects of the process of FIG. 19 may be implemented by one or more alternate mobile printers 36, printers 34 or programmable handheld printer 38 in singularity or combination.

In step 19.02 the mobile printer 26 makes a determination whether a print command has been received to initiate a print action, wherein the print command may be received in a print message P.MSG.001-P.MSG.N. If a print command to initiate a print command has not been received by the mobile printer 26 in step 19.03, the mobile printer 26 proceeds on to step 19.04 to perform alternate operations. If a command to initiate a print action has been received, the mobile printer 26 proceeds on to step 19.06 to determine if a label stock 1300 can be detected.

If a label stock 1300 is not detected by the mobile printer 26 in step 19.06, the mobile printer 26 proceeds on to step 19.08 to report a condition of an undetected label stock 1300 to the user and proceeds on to step 19.10 to determine if the mobile printer 26 shall (a.) additionally perform another execution of the loop of steps 19.02 through 19.18, or (b.) alternately proceed to perform alternate operations of step 19.04.

If the mobile printer 26 detects a label stock 1300 in step 19.06, the mobile printer 26 proceeds on to print the logo image data IMAGE.001, IMAGE.002 & IMAGE.003 in step 19.12, representations of the bar code data BARC.001 & BARC.002 in step 19.14 and representations of the alphanumeric value data DATA.001 & DATA.002 in step 19.16 on the label stock 1300. Additionally, it should be noted that the mobile printer 26 may perform steps 19.12, 19.14 and 19.16 simultaneously in whole or in part. The mobile printer 26 then proceeds on to step 19.18 to complete the printing process and to discharge the label stock 1300, i.e., the printed invented label LBL.001-LBL.N. The mobile printer proceeds from step 19.18 to step 19.02.

It is understood that steps 19.06 and 19.18 are not applicable to nor performed by the programmable handheld printer 38 in the generation of images 1302-1310 on to a container 18, 18A-18N.

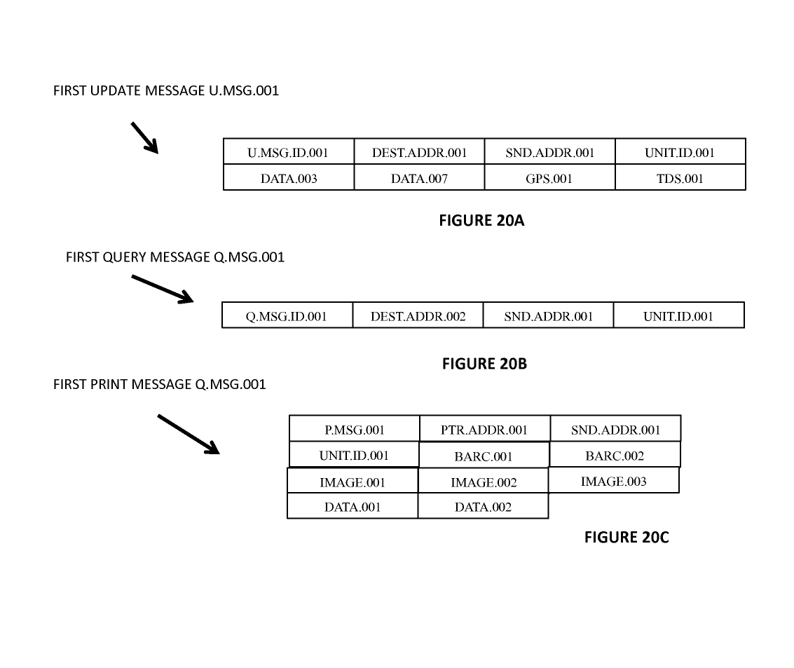

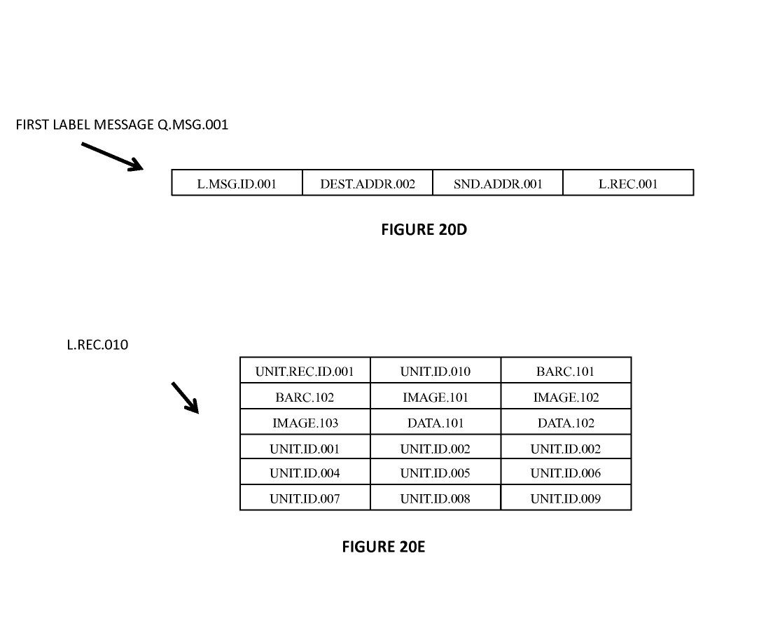

Referring now generally the Figures and particularly to FIG. 20A, FIG. 20A is a block diagram of the exemplary first update message UMSG.001 containing update information to be added to the first label record L.REC.001 to enable the data DATA.003, DATA.007, GPS.001 & TDS.001 contained within the first update message U.MSG.001 to be associated with the first product unit 14A and the first container 18A. The first message UMSG.001 includes a unique first update message identifier U.MSG.ID.001, a network destination address DEST.ADDR.001 of a system, device, server or computer 2, 24, 26 & 28 to which the first update message U.MSG.001 is to be sent, and additional data DATA.003 & DATA.007, including a first global positioning system data GPS.001 that indicates a geolocational position and a first time date stamp TDS.001 that specifies a particular date and time. The first update message also includes a sender network address of the GPS device 2 that originated the first update message U.MSG.001. It is understood that the invented method optionally enables systems, devices, servers and computers 2, 24, 26 & 28 to generate, populate, send and receive additional update messages U.MSG.002-U.MSG.N that send alternative and additional data DATA.004-DATA.006 & DATA.8-DATA.N to other systems, devices, servers and computers 2, 24, 26 & 28 in order to associate the additional information DATA.004-DATA.006 & DATA.8-DATA.N with alternate unit identifiers UNIT.ID.001-UNIT.ID.N, wherein each unit identifiers UNIT.ID.001-UNIT.ID.N is in turn associated with a label record L.REC.002-L.REC.N.

Referring now generally the Figures and particularly to FIG. 20B, FIG. 20B is a block diagram of the exemplary first query message Q.MSG that references the first unit identifier UNIT.ID.001 and further includes (a.) its own unique query message identifier U.MSG.ID.001, (b.) a sender network address SND.ADDR.001, and (c.) a destination network address DEST.ADDR.001. It is understood that the invented method optionally enables systems, devices, servers and computers 2, 24, 26 & 28 to generate, populate, send and receive additional query messages Q.MSG.002-Q.MSG.N that include alternate unit identifiers UNIT.ID.001-UNIT.ID.N, wherein each unit identifiers UNIT.ID.001-UNIT.ID.N is in turn associated with a particular label record L.REC.002-L.REC.N of which the sender is requesting a transmission of at least some of the information contained in the label record L.REC.001-L.REC.N in a query message Q.MSG.001-Q.MSG.N.

Referring now generally the Figures and particularly to FIG. 20C, FIG. 20C is a block diagram of an exemplary first printer message P.MSG.001 that directs the mobile printer 36 to print the first invented label LBL.001. The first printer message P.MSG.001 includes a network address PTR.ADDR.001 of the mobile printer 36 as a destination address, a sender network address of the GPS device 2 that originated the first print message P.MSG.001, the first unit identifier UNIT.ID.001 that is associated with the first label record L.REC.001, and information BARC.001, BARC.002, IMAGE.001, IMAGE.002, IMAGE.003, DATA.001 & DATA.002 that is to visually rendered with the label stock 1300 to form the first label LBL.001.

Referring now generally the Figures and particularly to FIG. 20D, FIG. 20D is a block diagram of the exemplary first responding label record message L.MSG.001 that references the first unit identifier UNIT.ID.001 and further includes (a.) its own unique label record message identifier L.MSG.ID.001, (b.) a sender network address SND.ADDR.001, and (c.) a destination network address DEST.ADDR.001. The payload of the first responding label record message L.MSG.001 includes a copy of some or all of the data of the first label record L.REC.001.

Referring now generally to the Figures and particularly to FIG. 20E, FIG. 20E is a block diagram of a group label record L.REC.010 that associates an invented pallet label LBL.010 that is coupled with a particular pallet 40 with a group of other invented labels LBL.001-LBL.009. The group label record L.REC.010 includes a plurality of unit identifiers UNIT.ID.001-UNIT.ID.009 that are each in turn separately associated with an individual label record L.REC.001-L.REC.009.

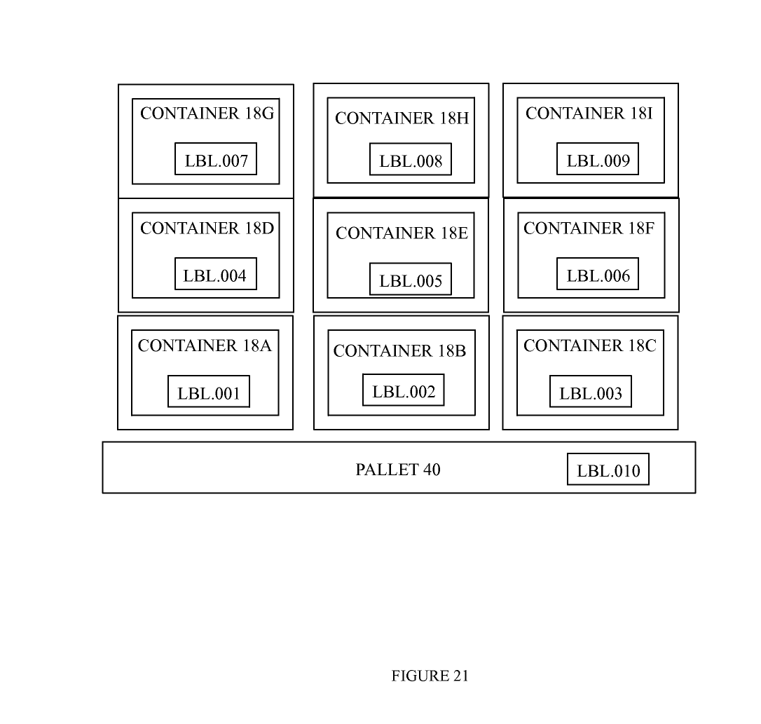

Referring now generally the Figures and particularly to FIG. 21, FIG. 21 is a front view of a pallet 40 that organizes and is associated with a plurality of containers 18A-18N wherein the pallet 40 and each container 18A-18I is marked with a unique invented label LBL.001-LBL.010.

The foregoing disclosures and statements are illustrative only of the present invention, and are not intended to limit or define the scope of the present invention. The above description is intended to be illustrative, and not restrictive. Although the examples given include many specificities, they are intended as illustrative of only certain possible applications of the present invention. The examples given should only be interpreted as illustrations of some of the applications of the present invention, and the full scope of the Present Invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

We claim:

1. A method of identifying a product unit, the method comprising:
a. Generating a plurality of unit identifiers, each unit identifier including a unique unit serial number;
b. Converting the plurality of unit identifiers into a machine-readable format;
c. Printing a unique image of each of the plurality of unit identifiers in the machine-readable format onto a separable adhesive label;
d. Affixing each adhesive label onto a separate unit container of a plurality of unit containers;
e. Distributing at least one unit container to a product source location;
f. Associating the label of the at least one unit container with a unit of goods at the product source location;
g. Associating unit identifier of the label of the at least one unit container with software record; and
h. Populating the software record with a goods identifier, the goods identifier indicating the identity of the unit of goods.

2. The method of claim 1, further comprising populating the software record with a source location identifier.

3. The method of claim 1, further comprising populating the software record with a GPS data.

4. The method of claim 1, wherein the unit of goods comprises agricultural products.

5. The method of claim 1, further comprising populating the software record with a supplier identifier, wherein the supplier identifier identifies an entity responsible for operations at the product source location.

6. The method of claim 5, wherein the unit of goods comprises agricultural goods and the supplier identifier identifies a farm operator.

7. The method of claim 1, further comprising populating the software record with a time date datum.

8. The method of claim 1, further comprising populating the software record with a container size value.

9. The method of claim 1, further comprising populating the software record with a weight of goods value.

10. The method of claim 1, further comprising populating the software record with a weight of goods measurement.

11. The method of claim 1, further comprising populating the software record with a worker identifier.

12. The method of claim 1, further comprising printing on the label a human-readable identifier of the source entity.

13. The method of claim 1, further comprising printing at least one unit identifier onto at least one label in both a human-readable format and a machine-readable format.

14. The method of claim 1 further comprising stamping at least one label with a farm operator identifier.

15. The method of claim 1, wherein a plurality of unit identifiers are individually printed onto individual labels, each label is affixed to an individual container of a plurality of containers, and the plurality of containers are distributed among a plurality of product source locations.

16. The method of claim 1, wherein at least one product location is a farm and the goods identifier identifies an agricultural product.

17. The method of claim 16, wherein the unit identifier conforms to a goods identification standard.

18. The method of claim 16, wherein the unit identifier conforms to a food safety product goods identification standard.

19. The method of claim 16, wherein the unit identifier conforms to the GTIN standard.

20. The method of claim 1, wherein at least one image of a machine-readable format of at least one unit identifier is a bar code.

21. The method of claim 20, wherein at least one image of a machine-readable format of at least one unit identifier is a three dimensional bar code.

22. The method of claim 1, wherein at least one image of a machine-readable format of at least one unit identifier comprises a QR code.

23. The method of claim 1, wherein at least one unit container is a pallet.

24. The method of claim 1, further comprising stamping a date onto at least one label after affixing the at least one label onto a unit container.

25. The method of claim 1, further comprising stamping a country identifier onto at least one label after affixing the at least one label onto a unit container.

26. The method of claim 1 wherein said populating the software record with a goods identifier is completed automatically by synchronizing data from a work site recording tool to a given unit identifier.

27. A method of identifying a unit of product, the method comprising:
a. Generating a plurality of unit identifiers, each unit identifier including a source entity identifier and a unique unit serial number;
b. Converting the plurality of unit identifiers into a machine-readable format;
c. Printing an image of each unit identifier of the plurality of unit identifiers in the machine-readable format onto an individual unit container of a plurality of unit containers;
d. Distributing at least one unit container to a product source location;
e. Associating the unit identifier printed onto the at least one unit container with a unit of goods at the product source location;
f. Associating the unit identifier of the at least one unit container with software record; and
g. Populating the software record with a goods identifier, the goods identifier indicating the identity of the unit of goods.

28. The method of claim 27, wherein at least one unit container is a pallet.

29. The method of claim 27, further comprising stamping a date onto the at least one unit container.

30. The method of claim 27, further comprising stamping a country identifier onto the at least one unit container.

31. A method of identifying a product unit, the method comprising:
a. Generating a unit identifier including a source entity identifier and a unique unit serial number;
b. Converting the unit identifier into a machine-readable format;
c. Imaging the one unit identifier in the machine-readable format onto a unit container;
d. Associating the unit identifier with a unit of goods;
e. Associating the unit identifier with a software record; and
f. Populating the software record with a goods identifier, the goods identifier indicating the identity of the unit of goods.

32. The method of claim 31, wherein at least one unit container is a pallet.

33. The method of claim 31, further comprising stamping a date onto the at least one unit container.

34. The method of claim 31, further comprising stamping a country identifier onto the at least one unit container.

35. The method of claim 31, wherein the unit identifier is imaged as a bar code.

36. The method of claim 31, wherein the unit identifier is imaged as a QR code.

37. The method of claim 31, wherein the unit identifier is imaged onto the unit container in the machine-readable by application of a coloring agent onto the unit container.

38. The method of claim 37, wherein the coloring agent is sprayed onto the unit container.

39. The method of claim 31, wherein the unit identifier is imaged onto the unit container in the machine-readable by the application of ink onto the unit container by means of a programmable handheld printer.

40. The method of claim 31, wherein the unit identifier is imaged onto the unit container in the process of manufacturing the unit container.
